(19) United States
(12) Patent Application Publication
(10) Pub. No.: US 2021/0147770 A1
(43) Pub. Date: May 20, 2021

(54) FERMENTED BEVERAGES FROM CANNABIS AND METHODS FOR PRODUCTION THEREOF

(71) Applicant: Honest Inc., Toronto (CA)

(72) Inventor: Michael V. WENDSCHUH, Miami, FL (US)

(73) Assignee: Honest Inc., Toronto (CA)

(21) Appl. No.: 16/629,720

(22) PCT Filed: Jul. 11, 2018
(86) PCT No.: PCT/CA2018/050846

§ 371 Date: Jan. 9, 2020

Related U.S. Application Data
(60) Provisional application No. 62/531,016, filed on Jul. 11, 2017.

(51) Int. Cl. C12G 3/026; C12H 3/04; C12C 5/02; C12C 7/00; A23L 2/38; A23L 2/56; A23L 33/105; C13K 1/02

(52) U.S. Cl. CPC C12G 3/026; C12H 3/04; C12C 5/026; C12C 7/00; A23V 2002/00; A23L 2/56; A23L 33/105; C13K 1/02; A23L 2/382

(57) ABSTRACT

A fermented beverage is described together with a method for its production from one or more component of a Cannabis plant. The beverage comprises carbohydrates derived from hydrolysis of cellulose and/or hemicellulose from Cannabis, as a fermentation substrate. The beverage may contain alcohol or may be non-alcoholic. Active phytocannabinoid compounds may be present, preferably in the non-alcoholic beverages. The method includes the steps of (a) obtaining a cellulose-rich pulp from the one or more components of the Cannabis plant, from which lignin and/or hemicellulose has been released (through any number of multiple prehydrolysis steps); (b) degrading the cellulose-rich pulp into carbohydrates (saccharification step) with enzymatic hydrolysis by one or more cellulose-degrading and/or hemicellulose-degrading enzymes, and/or with acid hydrolysis to form carbohydrates; (c) preparing a wort from the carbohydrates with (or if desired without) sufficient yeast nutritional requirements and flavoring from portions of the Cannabis plant; and (d) fermenting the wort to form the fermented beverage. (e) Optionally performing steps to finish the beer including but not limited to aging, alcohol removal, formulation and flavoring by addition of phytocannabinoids and/or terpenes, xylooligimers, and/or Cannabis extracts and/or Cannabis oils with or without accelerants (to accelerate the onset of the bioactive effect) and/or deccelerants (to shorten the duration of the bioactive effect) as desired. The optional removal of alcohol may be conducted by reverse osmosis or other process. Phytocannabinoids or flavorings may be introduced as desired.

### CROSS REFERENCE TO RELATED APPLICATIONS

This application claims the benefit of priority of U.S. Provisional Patent Application No. 62/531,016 filed Jul. 11, 2017, which is hereby incorporated by reference.

### FIELD

The present disclosure relates generally to fermented beverages and production methods. More particularly, the beverages and methods described involve fermentation of Cannabis and/or plant material derived from Cannabis.

### BACKGROUND

Fermented beverages, such as beer, are prepared by methods involving fermentation of a plant-derived carbohydrate, such as grain. Beer is conventionally brewed from the sprouted grain of the barley plant, which provides the fermentable substrate for microbes to convert to alcohol. Allowing the barley grain to sprout slightly, a process referred to as “malting”, permits ready access for yeast to the non-fibrous carbohydrate and protein content of the grain. Beer is typically flavored with hops, and more specifically: the flower of the hop plant (Humulus lupulus), a member of the Cannabaceae family.

Fermented beverages tend to contain alcohol, but alcohol may be removed in a processing step downstream of fermentation, the degree to which can be modified as desired. Further, brewing and/or fermenting processes may be adapted to result in a range of levels of alcohol formation in the resulting beverage, for example less than 0.5% and higher than 10% by volume.

While barley is the plant source from which beer-making methods conventionally derive fermentable carbohydrates, the use of alternative plant sources provides variety to the consumer. Rice, amaranth, sorghum, and millet, may be used as fermentable grains in beer, while other beers may include non-grain components such as peas or soybeans.

Contrary to the grain which predominantly contains starch, plant stalk and stem is made up of lignocellulose, a complex and recalcitrant polymeric structure composed of three main constituents 1) cellulose 2) hemicellulose and 3) lignin.

Cellulose is an organic polysaccharide consisting of linear chains of several hundred to many thousands of p linked D-glucose units. Hemicellulose is a random, amorphous, organic heteropolymer, made up of many constituent monomers such as arabinoxylans, xylose, arabinose, galactose and mannose, along with cellulose. Where cellulose is crystalline, strong, and resistant to hydrolysis, hemicellulose is easily hydrolyzed by dilute acid or hemicellulase enzymes. Lignin is a complex organic heteropolymer that acts like resin to hold the other two components together, lending rigidity. Lignins are cross-linked phenolic polymers. Compared to starch in grains, lignocellulose is recalcitrant, meaning that it is difficult to depolymerize (break up).

Hydrolysis is the chemical break down of a compound by a chemical process of decomposition involving the splitting of a bond and the addition of the hydrogen cation and the hydroxide anion of water. The hydrolysis can be carried out by a variety of means including by use of enzymes or by use of weak acid, amongst other means. Saccharification is the hydrolysis of polysaccharides to soluble sugars. For example, the conversion of cellulose to glucose and malt made from barley to the disaccharide maltose.

Because lignocellulose has a very complex polymeric structure, enzymes that break down lignocellulose are referred to as cellulase, hemicellullase, xylanase, ligninase, etc.

Cellulase is any of several enzymes produced chiefly by fungi or bacteria that catalyze cellulolysis, the decomposition of cellulose and related polysaccharides. Cellulases are sold in naturally occurring mixtures or cocktails of various such enzymes, that are produced together and that act serially or synergistically to decompose cellulosic material such as: beta-glucosidase (converts soluble glucooligomers to glucose); cellobiohydrolase (exoglucanases that cleave cellulose from the ends); endoglucanases (cleave cellulose internally); glucoside hydrolase (copper-dependent oxidases). Hemicellulase, xylanase, and ligninase are other enzymes which perform similar operations on hemicellulose, xylose and lignin respectively. Prehydrolysis is synonymous with pretreatment when used in the context of pulping. It is used often in association with conversion of lignocellulosic material and is a step which precedes hydrolysis. In prehydrolysis the cellulose, hemicellulose and lignin compositions are weakened or defibrated, meaning to be broken down or made into fiber. In this process the surface area is made more porous and is increased in area for enzyme or chemical accessibility.

An oligosaccharide is a carbohydrate whose molecules are composed of a relatively small number of monosaccharide units in polymeric form.

Brewing beer from substrates other than barley may have advantages to consumers, as such beers can be produced that are low in carbohydrate content, low in calories, and gluten free. Such beers may also have unique flavors that are desirable to consumers. In addition, in certain jurisdictions, marketing or taxation advantages may apply. For example, in Japan, making a beer from a starting material other than grain exempts the product from certain taxes, and as a result can be sold to consumers for lower cost.

The term “Cannabis” refers to the collection of plants commonly known as “hemp’ or “marijuana” which are in the genus “Cannabis”, and the term may also refer to extracts or purified compounds derived therefrom. There are three known species of Cannabis: Cannabis sativa, Cannabis indica, and Cannabis ruderalis. There is some debate as to whether Cannabis indica and Cannabis ruderalis are actually unique species, or rather subspecies of Cannabis sativa, but in any case, all are included in the definition of Cannabis used herein, as are any future species or subspecies yet to be discovered, engineered, or otherwise identified. Like hops, Cannabis is in the Cannabaceae family. For clarity, hops is not included in the definition of “Cannabis” used herein. The term “Cannabis” encompasses both hemp and marijuana. Hemp contains less than 0.3% w/w delta-9-tetrahydrocannabinol, often simply referred to as tetrahydrocannabinol or “THC.” Cannabis plants used for psychoactive properties, commonly referred to as “marijuana,” have THC levels above 0.3% w/w. Phytocannabinoids and other naturally occurring compounds, such as flavonoids and terpenoids, are present in both hemp and marijuana.

Hemp plants are used as a source of fiber from plant stalks or as a source of hempseed oil, largely for non-consumption purposes. Hemp can be refined into a variety of commercial items including paper, textiles, clothing, biodegradable plastics, paint, insulation, biofuel, food, and animal feed. Eating hemp or products derived from hemp is growing in popularity, for example: hemp seed oil, hemp hearts, hemp flour, hemp protein, hemp seed and hemp milk are now more readily available for consumers in the market. Consumers are realizing the benefits and versatility of both hemp and marijuana plants. The success of hemp products in grocery stores suggests that consumers enjoy the unique flavor of hemp, which has a taste generally the same as marijuana.

Cannabinoids are a structural class of alkaloid compounds with a similar core ring structure, capable of activating endocannabinoid receptors in humans for bioactive effects. Phytocannabinoids are naturally occurring cannabinoids made by plants. Some phytocannabinoids have psychoactive effects, including intoxicating effects, capable of altering the consumer's mood or temperament.

Phytocannabinoids include THC and cannabidiol (CBD), which are the two most well recognized cannabinoids. Also included are: CBC (cannabichromene), CBG (cannabigerol), CBL (cannabicyclol), CBV (cannabivarin), CBCV (cannabichromevarin), CBDV (cannabidivarin), CBGM (cannabigerol monomethyl ether), CBGV (cannabigerovarin), and THCV (tetrahydrocannabivarin), amongst many others. It is generally agreed that greater than 140 phytocannabinoids have been identified by various researchers. Acid forms of these cannabinoids are sometimes referred to with “A” included at the end of the acronym, such as cannabidiolic acid referenced as “CBDA”. Further information on cannabinoid nomenclature and structure can be found in provided in U.S. Pat. No. 9,095,554 (Lewis et al.).

Brewed or beer-like beverages produced from plant sources other than grains are described, for example in U.S. Pat. No. 8,147,884 which utilizes protein from green peas, and U.S. Patent Publication No. US2009/0285965 A1 that teaches preparation of beer-like beverage from soybean. The pea and bean portions of the plant used in these processes contain starches and proteins, unlike the plant stalk of the Cannabis plant, which is made of lignocellulose and particularly high in cellulose.

Cannabinoid-containing alcoholic drinks are described in U.S. Pat. No. 9,642,884, which are prepared by dissolving milligram quantities of isolated cannabinoids in ethanol and adding the resulting solution to a consumable alcohol drink such as vodka. U.S. Patent Publication No. US2015/0182455 A1 describes beverages formed by mixing extracted cannabinoids (in an oil form) with an emulsifier to allow an emulsion to form in an alcoholic beverage.

### SUMMARY

It is an object of the present disclosure to provide a fermented beverage made from the Cannabis plant or from one or more component thereof, and a method for producing such a beverage from a Cannabis plant or from one or more component thereof.

In one aspect there is provided a fermented beverage comprising one or more carbohydrate derived from hydrolysis of cellulose, hemicellulose, and/or lignocellulose from one or more component of a Cannabis plant.

In one example, a portion of the one or more carbohydrate derived from the hydrolysis is fermented to alcohol.

In one example, the fermented beverage comprising xylooligosaccharides.

In one example, the fermented beverage comprising about 0.1 to about 2.5% (w/w) xylooligosaccharides.

In one example, the fermented beverage comprising phenolics derived from said one or more components of a Cannabis plant.

In one example, the amount of concentration of said phenolics is greater than found in a fermented beverage not made with one or more components of a Cannabis plant.

In one example, said fermented beverage comprises less than about 0.5 grams per liter of furfural and 5-hydrolxymethyfurfural (5-HMF); less than about 0.1 grams per of liter formic acid; and less than about 0.2 grams per liter of levulinic acid, ferulic acid, p-coumaric acid, guaiacol, trans-cinnamic acid, and vanillic acid.

In one example, wherein said beverage is substantially free of (furfural, 5-hydrolxymethyfurfural (5-HMF), formic acid, levulinic acid, ferulic acid, p-coumaric acid, guaiacol, trans-cinnamic acid, and/or vanillic acid.

In one example, the fermented beverage comprising methyl-benzendiol.

In one example, the fermented beverage comprising 3-methyl-1,2-benzenediol and/or or 4-methyl-1,2-benzenediol

In one example, the fermented beverage comprising 2,3-butanediol, or isomers thereof.

In one example, the fermented beverage comprising 1,2-benzenediol.

In one example, the fermented beverage 1,4:3,6-dianhydro-alpha-d-glucopyranose, preferably about four times more as compared to a fermented beverage not made with one or more components of a Cannabis plant.

In one example, the fermented beverage comprising Isorbide, preferably about 4-6 times more as compared to a fermented beverage not made with one or more components of a Cannabis plant.

In one example, the one or more carbohydrate comprises: glucose—0.5 to 5.0 g/L, xylose—0.5 to 15 g/L, and/or cellobiose—0.5 to 5.0 g/L.

In one example, from which at least a portion of alcohol has been removed.

In one example, from which all of the alcohol has been removed.

In one example, the fermented beverage comprising up to 0.5% alcohol.

In one example, the fermented beverage comprising from 0.5% to 15% alcohol.

In one example, the Cannabis plant is a hemp plant.

In one example, the Cannabis plant is a marijuana plant.

In one example, the Cannabis plant comprises any combination of marijuana and hemp plants.

In one example, the fermented beverage, comprising a phytocannabinoid profile in proportions which may be found in a hemp plant.

In one example, the fermented beverage comprising a phytocannabinoid profile in proportions which may be found in a marijuana plant.

In one example, the fermented beverage comprising THC at a level of from about 0.1 to about 57 mg/L.

In one example, the fermented beverage comprising total phytocannabinoid level in the beverage from 0.15 mg/L to 71.4 mg/L.

In one example, the fermented beverage comprises a flavonoid selected from the group consisting of Orientin, Isoorientin, Vitexin, Isovitexin, Isoquercetin, Naringin, Myrcetin, Luteolin, or Quercetin.

In one example, the fermented beverage comprises: from 0.5 to 10 ppm Orientin; from 0.1 to 5 ppm Isoorientin; from 5.0 to 50 ppm Vitexin; from 0.1 to 5.0 ppm Isovitexin; from 0.5 to 10.0 ppm Naringin; from 0.1 to 5.0 ppm Myrcetin; from 0.1 to 5.0 ppm Luteolin; and from 0.1 to 5.0 ppm Quercetin.

In one example, the fermented beverage comprises at least 5 ppm of Vitexin.

In one example, the fermented beverage further comprising natural flavoring from malted and/or toasted hemp seeds or both.

In one example, the fermented beverage further comprising hops.

In one example, the fermented beverage consisting of water, a carbohydrate derived from the hydrolysis of cellulose, hemicellulose and/or lignocellulose from one or more component of Cannabis plants, hops, phytocannabinoids from the Cannabis plant, and alcohol at a level of up to about 15% v/v (a 15% “ABV”).

In one aspect there is described a fermentable extract for use in preparation of a fermented beverage, said extract comprising one or more carbohydrate derived from hydrolysis of cellulose, hemicellulose, and/or lignocellulose from one or more component of a Cannabis plant.

In one example, the or more carbohydrate comprises one or more of arabinose, galactose, glucose, mannose, xylose and cellobiose.

In one example, the fermented extract comprising phenolics derived from said one or more components of a Cannabis plant.

In one example, the amount of concentration of said phenolics is greater than found in a fermented beverage not made with one or more components of a Cannabis plant.

In one example, said extract comprises less than about 0.5 grams per liter of furfural and 5-hydrolxymethyfurfural (5-HMF); less than about 0.1 grams per of liter formic acid; and less than about 0.2 grams per liter of levulinic acid, ferulic acid, p-coumaric acid, guaiacol, trans-cinnamic acid, and vanillic acid.

In one example, the fermented extract substantially free of (furfural, 5-hydrolxymethyfurfural (5-HMF), formic acid, levulinic acid, ferulic acid, p-coumaric acid, guaiacol, trans-cinnamic acid, and/or vanillic acid.

In one example, the fermentable extract, comprising on a weight basis: glucose at 6.5 to 15.0%; xylose at 1.0 to 2.5%; galactose at 0.01 to 0.2%; arabinose at 0.001 to 0.2%; mannose at 0.01 to 0.30%; and/or cellobiose at 0.05 to 0.3.

In one example, the fermentable extract comprising on a weight basis:
glucose at about 7.7%;
xylose at about 2.0%;
galactose at about 0.02%;
arabinose at about 0.005%;
mannose at about 0.05%; and/or
cellobiose at about 0.15%.

In one example, the ratio on a weight basis of glucose to the total of xylose, galactose, and mannose (XGM) combined is from about 2.5:1 to 15:1.

In one example, the ratio on a weight basis of glucose to the total of xylose, galactose, and mannose (XGM) combined is from 4:1 to 8:1.

In one example, the extract comprises:
from 5 to 12 ppm Orientin;
from 0.1 to 20 ppm Isoorientin;
from 5.0 to 600 ppm Vitexin;
from 0.1 to 5.0 ppm Isovitexin;
from 0.1 to 2.0 ppm Naringin;
from 0.1 to 5.0 ppm Myrcetin; and/or
from 0.1 to 5.0 ppm Luteolin.

In one aspect there is described a method for producing a fermented beverage from one or more component of a Cannabis plant, comprising the steps of: (a) obtaining a cellulose-rich pulp from the one or more components of the Cannabis plant, which has been treated to release lignin and/or hemicellulose; (b) degrading the cellulose-rich pulp into carbohydrates (saccharification step) with enzymatic hydrolysis by one or more cellulose-degrading and/or hemicellulose-degrading enzymes, and/or with acid hydrolysis, to form carbohydrates; (c) preparing a wort from the carbohydrates with or without sufficient yeast nutritional requirements and flavoring from portions of the Cannabis plant; and (d) fermenting the wort to form the fermented beverage. (e) Optionally performing steps to finish the beer including but not limited to aging, alcohol removal, formulation and flavoring by addition of phytocannabinoids and/or terpenes, xylooligimers, and/or Cannabis extracts and/or Cannabis oils with or without accelerants, to accelearate the onset of the bioactive effect, and/or deccelerants, to shorten the duration of the bioactive effect, as desired.

In one example the step of (a) obtaining the pulp comprises releasing lignin by reducing the one or more component of the Cannabis plant, to form a lignin-rich liquor and a cellulose-rich pulp, which cellulose-rich pulp may also contain an appreciable amount of hemicellulose.

In one example the step of (a) obtaining the pulp comprises releasing hemicellulose by reducing the one or more component of the Cannabis plant, to form a hemicellulose-rich liquor and a cellulose-rich pulp.

In one example wherein step (a) is performed using a batch and/or a continuous reactor process.

In one example wherein step (a) additionally comprises hydrothermal prehydrolysis of the pulp.

In one example wherein step (a) additionally comprises thermal-mechanical prehydrolysis of the pulp.

In one example wherein step (a) additionally comprises the supercritical CO2 prehydrolysis of the pulp.

In one example wherein step (a) additionally comprises supercritical CO2 and/or sub-critical or near-critical water prehydrolysis of the pulp.

In one example wherein step (a) additionally comprises prehydrolysis of the pulp as performed by a counter-current reactor designed for continuous processing of lignocellulosic materials.

In one example wherein step (a) additionally comprises prehydrolysis of the pulp as performed by a counter-current reactor designed for or capable of continuous processing of lignocellulosic materials.

In one example wherein step (b) comprises separating the carbohydrates into a carbohydrate-rich fermentable extract.

In one example wherein the Cannabis plant is a hemp plant.

In one example wherein the Cannabis plant is a marijuana plant.

In one example wherein the Cannabis plant comprises any combination of any portions of hemp plants and marijuana plants.

In one example wherein the one or more components of the Cannabis plant comprise stalks, stems, leaves, flowers, seeds, roots, or combinations thereof.

In one example wherein the one or more component of the Cannabis plant comprises hemp stalks from which seeds and leaves have been removed.

In one example wherein the one or more component of the Cannabis plant comprises marijuana stalks from which seeds and leaves have been removed.

In one example wherein the one or more component of the Cannabis plant is reduced in step (a) by cutting or mashing.

In one example wherein step (a) comprises heating to a temperature of from 70 to 450° C.

In one example wherein step (a) comprises heating to a temperature of from 150 to 240° C.

In one example wherein in step (a) the lignin and/or hemicellulose is released by milling the one or more component of the Cannabis plant with an aqueous solution of pH 8 to 13.

In one example wherein the one or more component of the Cannabis plant is processed in a reactor, and the aqueous solution washes the component during processing through the reactor.

In one example, an alkaline solution is used to wash the one or more component of the Cannabis plant in the reactor.

In one example wherein the step of (b) degrading the pulp occurs over 24 to 124 hours.

In one example wherein the step of (b) the pulp is degraded using acid hydrolysis or supercritical CO₂.

In one example wherein in step (b) the pulp is degraded by one or more cellulose-degrading enzymes.

In one example wherein the one or more cellulose-degrading enzymes are from F

In one example wherein the cellulose-degrading enzymes are from Aspergillus niger and/or Trichoderma reesei or both.

In one example wherein in step (b) the pulp is degraded by one or more hemicellulose-degrading enzymes.

In one example wherein in step (b) the pulp is degraded by one or more of Attenuzyme Pro, Amylase AG 300 L, Cellucast 1.5 L, Ultraflo Max, Viscozyme L (Novozyme); Cellulase 2000 L, Optimash Barley, Viscamyl Flow (Genencor/DuPont) Rohalase Barley L, Rohament CEP, Rohalase SEP (ABEnzymes), a blend of enzymes of food grade quality, drisealases, laminarinases, endo-glucanases, cellobiohydrolases, beta-glucosidases, xylanases, ligninases, and/or lyticases, cellulases from Aspergillus niger, cellulases from Aspergillus sp., cellulases from Trichoderma reesei, cellulases from Trichoderma sp., cellobiohydrolase I and II from Hypocrea jecorina, and/or mixtures thereof.

In one example wherein the wort prepared in step (c) comprises free amino nitrogen in an amount of from 100 to 1000 mg/g in the wort.

In one example wherein the wort comprises free amino nitrogen of from 300-600 mg/g.

In one example wherein 100% v/v of the carbohydrate in the wort is derived from Cannabis plant.

In one example wherein any amount between 1% and 100% v/v of the carbohydrate in the wort is derived from Cannabis plant.

In one example wherein glucose comprises at least 70% of the carbohydrate in the wort.

In one example wherein xylose comprises at least 15% of the carbohydrate in the wort.

In one example wherein the carbohydrates in the wort comprise: glucose at 6.5 to 15.0%;
xylose at 1.0 to 2.5%;
galactose at 0.01 to 0.2%;
arabinose at 0.001 to 0.2%
mannose at 0.01 to 0.30%; and
cellobiose at 0.05 to 0.3.

In one example wherein the carbohydrates in the wort comprise: glucose at about 7.7%;
xylose at about 2.0%;
galactose at about 0.02%;
arabinose at about 0.005%;
mannose at about 0.05%; and
cellobiose at about 0.15%.

In one example wherein the wort comprises Cannabis seeds, Cannabis flowers, leaves, hops, or a combination thereof.

In one example wherein the Cannabis seeds comprise toasted or malted Cannabis seeds, or both.

In one example wherein the wort comprises hops.

In one example wherein phytocannabinoids, whether in the form of a marijuana oil, or as purified phytocannabinoids or in the form of leaves are added to the wort.

In one example wherein terpenes are added to the wort.

In one example wherein flavinoids are added to the wort.

In one example wherein xylooligomers derived from the Cannabis plant are added to the wort.

In one example further comprising the step of removing alcohol from the beverage to a level less than 5% alcohol by volume in the beverage.

In one example further comprising the step of removing alcohol from the beverage to a level less than 0.5% alcohol by volume in the beverage.

In one example further comprising the step of removing all alcohol from the beverage.

In one example wherein phytocannabinoids are added to the beverage.

In one example wherein the THC level in the beverage is from about 0.1 to about 57 mg/L.

In one example wherein the total phytocannabinoid level in the beverage from 0.15 mg/L to 71.4 mg/L.

In one aspect there is described a fermented beverage produced according to the methods herein

In one aspect, the present disclosure provides a fermented beverage where yeast converted one or more of the carbohydrates derived from saccharification of cellulose, hemicellulose, and/or lignocellulose from one or more component of a Cannabis plant.

In another aspect, the present disclosure provides a fermentable extract for use in preparation of a fermented beverage, said extract comprising one or more carbohydrate derived from the saccharification of cellulose, hemicellulose, and/or lignocellulose from one or more component of a Cannabis plant.

In another aspect, the present disclosure provides a method for producing a fermented beverage from one or more component of a Cannabis plant, comprising the steps of: (a) obtaining a cellulose-rich pulp from the one or more components of the Cannabis plant, from which lignin and/or hemicellulose has been released (through any number of multiple prehydrolysis steps); (b) degrading the cellulose-rich pulp into carbohydrates (saccharification step) with enzymatic hydrolysis by one or more cellulose-degrading and/or hemicellulose-degrading enzymes, and/or with acid hydrolysis and/or super critical hydrolysis to form carbohydrates; (c) preparing a wort from the carbohydrates with sufficient yeast nutritional requirements and flavoring from portions of the Cannabis plant; and (d) fermenting the wort to form the fermented beverage. (e) Performing steps to finish the beer including but not limited to aging, alcohol removal, formulation and flavoring by addition of phytocannabinoids and/or terpenes, xylooligimers, and/or Cannabis extracts and/or Cannabis oils with or without accelerants (which accelerate the onset of the bioactive effect) and/or deccelerants (which shorten the duration of the bioactive effect) as desired.

In another aspect, provided herein are alcohol-containing beverages and/or non-alcoholic beverages, prepared according to the described method.

Other aspects and features of the present disclosure will become apparent to those ordinarily skilled in the art upon review of the following description of specific embodiments.

### BRIEF DESCRIPTION OF THE DRAWINGS

Embodiments of the present disclosure will now be described, by way of example only, with reference to the attached Figures.

FIG. 1 is a flow diagram depicting a high level schematic of the method of producing a fermented beverage, as described herein.

FIG. 2 is a flow diagram depicting several optional steps in the process with more detail including various stages of prehydrolysis using different technology and saccharification producing an extract for the production of wort for brewing. For clarity several of the steps listed in FIG. 2 are optional. But by carrying out a subset of these steps as described herein, it is possible to create such a beverage. For clarity Examples 8, 9, 10, and 11 are one example of an inventive permutations from FIG. 2.

FIG. 3 is a beer evaluation scorecard used in Example 13.

### DETAILED DESCRIPTION

Generally, the present disclosure provides a fermented beverage and a method for preparing a fermented beverage from one or more component of the Cannabis plant.

The Fermented Beverage

The fermented beverage contains one or more carbohydrate(s) derived from prehydrolysis and saccharification of cellulose, hemicellulose, and/or lignocellulose from one or more component of a Cannabis plant. Carbohydrate contained in the beverage is derived from prehydrolysis and saccharification of the plant components cellulose, hemicellulose, and/or lignin.

At least a portion of the carbohydrate derived from the hydrolysis is partially fermented to form alcohol in the fermented beverage. An exemplary carbohydrate profile of the fermented beverage may be: glucose—0.5 to 5.0 g/L; xylose—0.5 to 15 g/L; galactose 0.1 to 2 g/L; mannose 0.1 to 2.0 g/L; cellobiose—0.5 to 5.0 g/L; maltotriose 0.5 to 10 g/L; gluco-oligomers 0.1 to 10 g/L and xylooligomers 0.1 to 10 g/L. Other profiles are also possible.

The fermented beverage may have a portion of the alcohol removed, for example, all of the alcohol formed in the fermented beverage may be removed. In some embodiments, the beverage may contain low alcohol, such as up to 0.5% alcohol by volume. In other embodiments, the alcohol content may be from 0.05% to 20% alcohol by volume.

The Cannabis plant used to make the fermented beverage may be a hemp plant, or may be a marijuana plant, or may be a combination of both. The resulting beverage may have a phytocannabinoid profile reflecting the proportions of phytocannabanoids as found in a hemp plant, or a marijuana plant. For example, the THC level in the beverage may be so low as to be undetectable, but when present, may be from about 5.7 to about 57 mg/L (2 to 20 mg/350 ml bottle) and the total phytocannabinoid level in the beverage may be from 8.57 mg/L to 71.4 mg/L (3 to 25 mg/350 ml bottle). Further, the beverage may contain one or more flavonoid selected from the group consisting of Orientin, Isoorientin, Vitexin, Isovitexin, Isoquercetin, Naringin, Myrcetin, Luteolin, or Quercetin. An exemplary flavonoid profile in the beverage may be from 0.5 to 10 ppm Orientin; from 0.1 to 5 ppm Isoorientin; from 5.0 to 50 ppm Vitexin; from 0.1 to 5.0 ppm Isovitexin; from 0.5 to 10.0 ppm Naringin; from 0.1 to 5.0 ppm Myrcetin; from 0.1 to 5.0 ppm Luteolin; and from 0.1 to 5.0 ppm Quercetin. Other flavonoids may also be present in the profile, and other profiles are also possible. An exemplary level of a particular flavonoid in the beverage may be Vitexin at a level of at least 5 ppm.

The fermented beverage may include a number of other components, such as for example natural flavoring from malted and/or toasted Cannabis seeds.

The fermented beverage may include terpenes from the Cannabis plant and/or from hops. An exemplary terpene profile consists of, but not limited to Nerolidol-trans—1-5 ppm; A-Bisabolol 2-15 ppm; B-caryophyllene 2-10 pm; Caryophyllene oxide 1-5 ppm; Guaiol 1-5 ppm; Humulene 1-10 ppm; and Terpinolene 1-10 ppm.

An exemplary beverage may be one that consists of water, the monomeric and polymeric carbohydrates derived from the prehydrolysis and saccharification of Cannabis; terpenes, and phenolics derived from hops and Cannabis; higher alcohols and esters derived from yeast metabolism of the carbohydrates and amino acids; phytocannabinoids, flavonoids, terpenes and omega 3-fatty acids extracted from the Cannabis plant and ethyl alcohol at a level of up to about 20% v/v. A wide variety of other beverages are possible.

Phytocannabinoids, terpenes and other compounds found in trichomes on Cannabis leaves and/or flowers may contribute psychoactive effect when added to the beverage.

Adding Active Ingredients or Excipients. Further biologically active ingredients or excipients may be added to the beverage which are capable of altering the dose-response curve of the biological effect of the intoxicating compounds present. For example, excipients may be added which, when combined with phytocannabinoids or Cannabis oil in the appropriate process, shorten the duration of intoxicating effect, and/or shorten the onset time of intoxicating effect of the beverage.

The added active ingredients may be included in the wort, during the step of preparing the wort. Alternatively, such additions during the step of degrading the cellulose-rich pulp with enzymatic hydrolysis, and/or during or after fermentation or just before carbonation is also possible.

A fermentable extract is described herein, which may be used to prepare the fermented beverage. The extract includes carbohydrates derived from hydrolysis of cellulose, hemicellulose, and/or lignocellulose from one or more component of a Cannabis plant. For example, such carbohydrates may comprise arabinose, galactose, glucose, mannose, xylose, xylo-oligomer, gluco-oligomer, maltotriose and/or cellobiose. The fermentable extract produced in preydrolysis and saccharification may, for example, have the following profile: glucose at 65 to 150 g/L, such as about 77 g/L; xylose at 5.0 to 25 g/L, such as about 10 g/L; galactose at 0.1 to 2.0 g/L, such as about 0.2 g/L; arabinose at 0.01 to 2.0 g/L, such as about 0.03 g/L; mannose at 0.1 to 0.4 g/L, such as about 0.3 g/L; and cellobiose at 0.5 to 3.0 g/L, such as about 1.5 g/L. Other profiles of the extract are also possible. Other profiles of the extract are also possible. An exemplary ratio, on a weight basis, of glucose to the total of xylose, galactose, and mannose (XGM) combined may be from about 2.5:1 to 9:1, such as from 4:1 to 6:1 in the extract. The extract may then go on to be fermented, such as for brewing a beer.

Flavonoids may be, but do not necessarily have to be found in the fermentable extract. An exemplary profile of the flavonoid profile of such a beverage might be: from 5 to 12 ppm Orientin; from 0.1 to 20 ppm Isoorientin; from 5.0 to 600 ppm Vitexin; from 0.1 to 5.0 ppm Isovitexin; from 0.1 to 2.0 ppm Naringin; from 0.1 to 5.0 ppm Myrcetid from 0.1 to 5.0 ppm Luteolin. Other profiles are also possible. Having no flavonoids present or detectable is also possible.

### The Method Used to Produce Fermented Beverage

The method used to produce the fermented beverage, utilizing one or more component of a Cannabis plant, comprises the steps of: (a) obtaining a cellulose-rich pulp from the one or more component of the Cannabis plant, from which portions of the lignin and/or the hemicellulose have been released by any of the following types of prehydrolosis: hydrothermal; thermal-mechanical; thermal-mechanical with chemical, supercritical CO₂ and/or sub-critical and/or near-critical water prehydrolysis or steam explosion; (b) degrading the cellulose-rich pulp into carbohydrates with/saccharification, such as by enzymatic hydrolysis with one or more cellulose-degrading and/or hemicellulose-degrading enzymes, or by acid hydrolysis, such as with a dilute acid, or by super critical solvents hydrolysis so as to form a carbohydrate extract; (c) preparing a wort from the carbohydrate extract; and (d) fermenting the wort to form the fermented beverage. These steps, as well as other optional steps may be carried out in any order that permits.

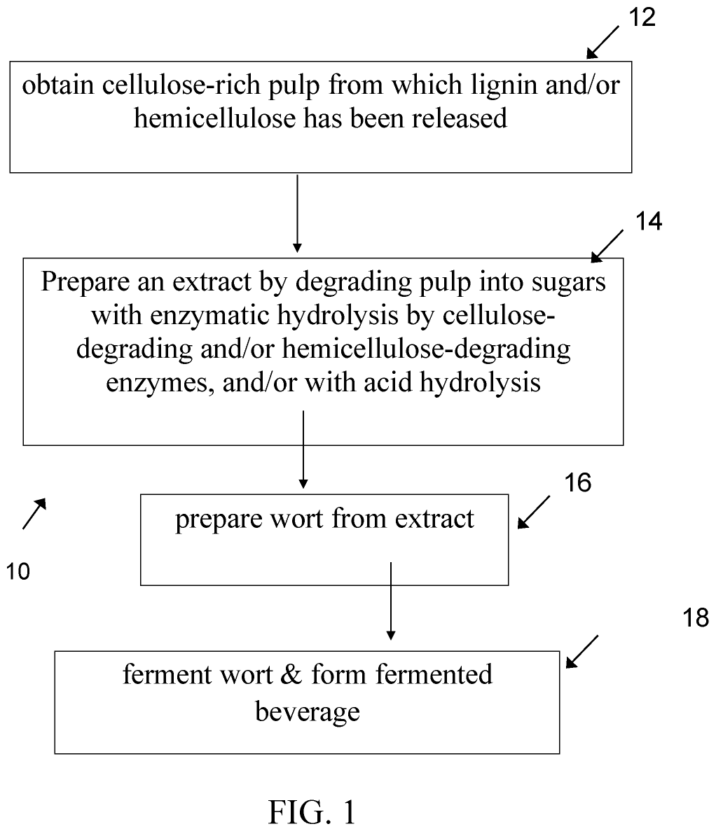

FIG. 1 is a flow diagram depicting a high level schematic of the method of producing a fermented beverage, as described herein.

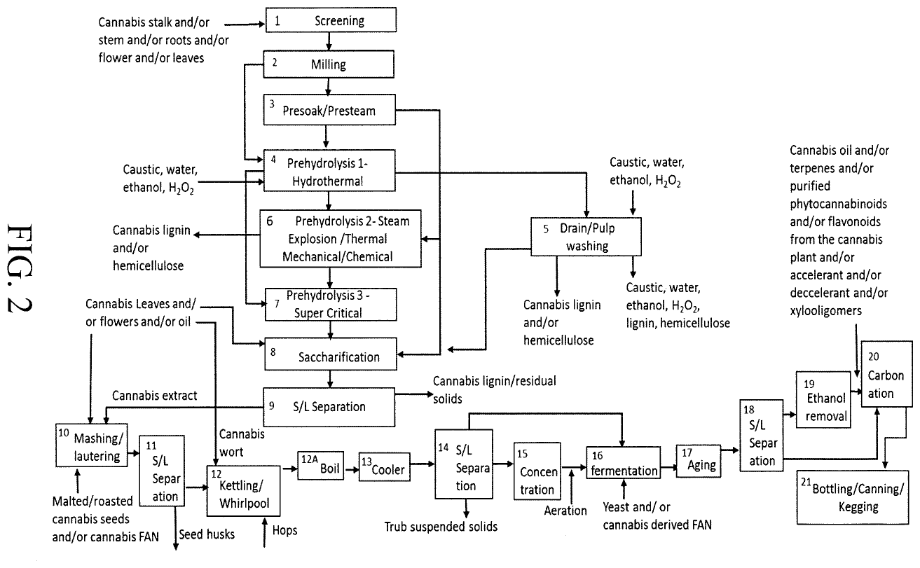

FIG. 2 is a flow diagram depicting several optional steps in the process with more detail including various stages of prehydrolysis using different technology and saccharification producing an extract for the production of wort for brewing. For clarity several of the steps listed in FIG. 2 are optional, and completing all listed steps in order would not necessarily result in the desired beverage being created as described herein. But by carrying out a subset of these steps as described herein, it is possible to create such a beverage. For clarity Examples 8, 9, 10, and 11 are one example of an inventive permutations from FIG. 2.

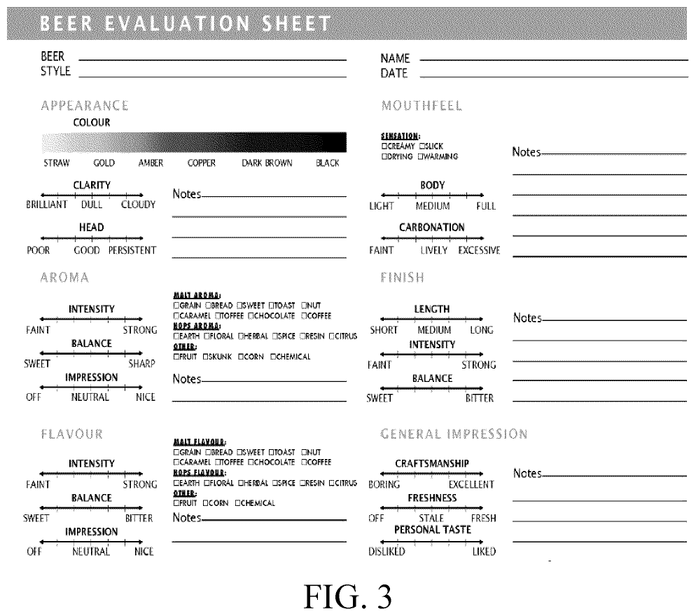

FIG. 3 is a beer evaluation scorecard used in Example 13.

The prehydrolysis steps 4, 6, 7 in FIG. 2 are methods to prepare the plant material for further degradation to carbohydrates and make the fiber accessible to enzymes and/or acid and/or super critical solvents for saccharification. Step 5 is an optional pulp washing step between prehydrolysis and saccharification. Step 8 is the saccharification step itself. Step 9 functions to remove residual suspended solids and lignin from the soluble carbohydrate extract. Steps 10 through 21 are typical brewing unit operations.

Various permutations of any subset of the steps in FIG. 2 can be performed. For example, the Cannabis could be milled (FIG. 2, step 2) and then presoaked (FIG. 2, step 3) with an alkaline solution, followed by a prehydrolysis that is hydrothermal (FIG. 2, step 4) where hemicellulose and lignin are removed by draining and washing (FIG. 2, step 5), followed by an enzymatic saccharification step (FIG. 2, step 6), followed by solid/liquid separation (FIG. 2, step 9) followed by steps 10 through 20. This is detailed in example 8.

Another permutation of steps is to start with Cannabis being milled (FIG. 2, step 2) followed by a presoaking (FIG. 2, step 3) with an alkaline solution, followed by a prehydrolysis that is hydrothermal (FIG. 2, step 4) where hemicellulose and lignin are removed by draining and washing (FIG. 2, step 5), followed by a second prehydrolysis step involving supercritical CO2 and sub-critical and/or near critical water prehydrolysis (FIG. 2, step 7), followed by a dilute acid saccharification step (FIG. 2, step 6), followed by solid/liquid separation (FIG. 2, step 9) followed by steps 10 through 20. This is detailed in example 9.

A further permutation of the steps in FIG. 2 is to start with the Cannabis being milled (FIG. 2, step 2) followed by a presoak (FIG. 2, step 3) with alkaline, followed by a prehydrolysis that is hydrothermal (FIG. 2, step 4) where hemicellulose and lignin are removed by draining and washing (FIG. 2, step 5), followed by a second prehydrolysis step involving supercritical CO2 and sub-critical and/or near critical water prehydrolysis (FIG. 2, step 7), followed by an enzymatic acid saccharification step (FIG. 2, step 6), followed by solid/liquid separation (FIG. 2, step 9) followed by steps 10 through 20. This is detailed in example 10.

Alternatively, from FIG. 2, the Cannabis could be milled (FIG. 2, step 2) followed by a presoaking step (FIG. 2, step 3), followed by a prehydrolysis that is hydrothermal (FIG. 2, step 4) without chemicals where a predominantly hemicellulose stream is removed by draining and washing (FIG. 2, step 5), followed by a second prehydrolysis step involving thermomechanical prehydrolysis using a refiner (FIG. 2, step 6) followed by an enzymatic acid saccharification step (FIG. 2, step 6), followed by solid/liquid separation (FIG. 2, step 9) followed by steps 10 through 20. This is detailed in example 11.

In addition to those listed above, other combinations and permutations of the steps in FIG. 2 are also possible.

The Cannabis plant may be a hemp plant or a marijuana plant, or a mixture of the two, and one or more of the following components of the Cannabis plant may be used: Cannabis plant comprising stalks, stems, buds, leaves, flowers, seeds, roots, or combinations thereof. For example, the plant may be a hemp plant, and it may be one in which the seeds and leaves have been removed. The plant components may be reduced in step (a) by cutting or mashing.

Cannabis Plants and One or More Component Thereof: Stalks, Stems, Leaves, Flowers, Seeds, and/or Roots. The Cannabis plant or one or more component thereof for use in the method may be derived from hemp or marijuana plants. Any variety of these source plants may be used. The stalks, stems, leaves, buds, flowers, seeds, and/or roots may be used alone, in combination, or as a component of the whole plant. The plant or component(s) may be ones that would otherwise be treated as waste from other Cannabis-related applications that may utilize other portions of the plant matter, such as components remaining after leaves and buds are removed. Individual plants, or a blend of hemp and marijuana stalks, stems, leaves, buds, flowers, seeds, roots, or a combination thereof may be used in the process.

The plants or component(s) thereof may typically be ones from which seeds and leaves have been removed. Alternatively, the method could employ full plants, without previous removal of the seeds, buds, and leaves. Thus, removal of seeds, buds, and leaves from other components is entirely optional. Advantageously, when stalks, roots and/or stems are the component used alone, higher value portions of the plant may be separated and forwarded toward use in other Cannabis-related industries. Similarly, when stems, leaves, buds, flowers, seeds or roots are the component used alone, without other portions of the plant, the plant may be separated and forwarded toward use in separate Cannabis-related industries. Whole plants may be used in their entirety.

If it is desirable for the final beverage to convey a psychoactive effect, the beverage must contain psychoactive phytocannabinoids. Such phytocannabinoids can be found to a minimal extent in the stalks, stems and roots of the Cannabis plant (a negligible amount of phytocannabinoids may also be found in the seeds), and to a much larger extent in the leaves and flower of the plant, or in an extracted marijuana oil, or as purified phytocannabinoids. As per FIG. 2, these phytocannabinoids may be optionally added to the beer at different times to create different flavours and/or effects. In one embodiment, supplemental phytocannabinoids (in addition to the small amounts found in the stalks stems and/or roots) can be added before the saccrification as an oil, or as purified phytocannabinoids, and/or in the form leaves and/or flowers. In another embodiment, supplemental phytocannabinoids (in addition to those found in the stalks, stems and/or roots) may be added before or to the kettle in the brewing process, or at any time between the kettle and the end of fermentation in the form of marijuana oil, purified phytocannabinoids, and/or flower and/or leaves. In yet another embodiment, decarboxylated purified phytocannabinoids or decarboxylated marijuana oil may be added during the finishing process, just prior to carbonation. It is possible to add supplemental phytocannabinoids at multiple steps if desired.

The plant or plant component(s) used in the method described herein are reduced, such as by chopping, crushing, milling, refining, digesting, flashing, hydrolyzing or mashing, to form a biomass comprising both lignin and/or hemicellulose and cellulose components. Separating the lignin from the cellulose and/or hemicellulose into enriched fractions permits two different fractions to be processed and broken down further into two different polysaccharide-based feed stocks for fermentation, previously viewed as recalcitrant to fermentation or other forms of breakdown. Breaking down lignin, cellulose, hemicellulose, and lignocellulosic materials into component mono- or di-saccharide units through enzymatic hydrolysis, acid hydrolysis and/or super critical hydrolysis leads to carbohydrates. The 6-carbon glucose molecule is the primary monosaccharide carbohydrate yielded from a cellulose-rich fraction, while 6-carbon glucose and xylose, a 5-carbon aldopentose carbohydrate, are included in the breakdown of hemicellulose-rich fractions, which may also contain lignocellulosic fractions. Removal of the xylose-containing polysaccharides and lignin-containing polysaccharides renders a cellulose-rich fraction that ensures a high glucose content, optimal for fermentation to ethanol. Alternately or in addition to the steps described before, the hemicellulose portion may be left in the fraction and hemicellulose-degrading yeast may be used later in the process.

Milling and Particle Size Reduction

The plant or component(s) may be reduced in size by milling to a smaller size, and/or screening to reduce size further. Screening the milled plant or component(s) through a screen or mesh having a size of from about 200 microns, to about 2.0 inches, for example: 1.5″, 1.25″, 1″, 0.75″, 0.5″, 0.33″, 2000 microns, 1000 microns, 750 microns, 500 microns, 250 microns, 200 microns or less, may occur prior to directing these size-reduced portions of the plant or component(s) into an apparatus for further reduction (mashing, crushing, chopping, or refining) in preparation for downstream steps. The size of the particles should conform to the size of the reactor into which the particles will be fed in downstream steps. For example, depending on the scale of the process, the reactor may be bench-scale, lab-scale, pilot-scale or fully scaled up for commercial production. An exemplary apparatus is a knife mill, a hammer mill, a grinder, a commercial-grade food processor, or other technology for milling.

Prehydrolysis Steps

In step (a) of the method, a number of prehydrolysis steps may be conducted, either singly or in combination, such as hydrothermal; thermal-mechanical; thermal-mechanical with chemical, supercritical CO₂ and/or sub-critical and/or near-critical water prehydrolysis or steam explosion of the pulp as described herein.

Optionally a pre-soak or pre-steam can be performed to moisten and soften the biomass particles (FIG. 2, step 3).

A variety of conditions are possible in the method described, for example in step (a), hydrothermal heating to a temperature of from 150 to 240° C. may be conducted. An exemplary range may be, for example from 150 to 190° C. for a first stage time of 3 seconds to 3 hours at a first stage pressure of 0 to 450 pounds per square inch gauge (psig). The reactor may be a Pandia type digester or column or other, horizontal or vertical, batch or continuous. A catalyst may or may not be used and hemicellulose may or may not be preferentially separated. This is the hydrothermal prehydrolysis shown on FIG. 2, step 4. After this step the soluble hemicellulose and/or lignin can be drained off of the pulp with washing with solvents such as water, aqueous water-ethanol, and aqueous-hydrogen peroxide (FIG. 2, step 5).

In step (a) the lignin and/or hemicellulose may be solubilized and released by milling the one or more component of the Cannabis plant and reacting it with an aqueous solution of pH 8 to 13. Further, the processing may be conducted in a reactor, and the aqueous solution may wash the component during processing through the reactor.

A variety of conditions are possible in the method described, for example in step (a), thermomechanical processing to a temperature of from 60° C. to 240° C. may be conducted. An exemplary range may be, for example from 80° C. to 190° C. This can be done at atmospheric pressure or at elevated pressure. This is the thermomechanical prehydrolysis shown on FIG. 2, step 6. In this prehydrolysis temperature and mechanical action on the fiber is predominant. The process equipment may be a reactor or a refiner, an extruder or a reactor that pressurizes and then flashes such as steam explosion. Chemicals or solvents may be used in combination such as alkaline, acid, hydrogen peroxide or ethanol. This step may be preceded by step 4, hydrothermal prehydrolysis

A variety of conditions are possible in the method described, for example in step (a), super critical solvent processing to a temperature of from 300° C. to 400° C. may be conducted. An exemplary range may be, for example from 340-400° C. This is the super critical prehydrolysis shown on FIG. 2, step 7. This prehydrolysis can be preceded by a first stage hydrothermal step (FIG. 2, step 4). This is followed by a second reactor for supercritical hydrolysis using CO₂ and or water and heat and pressure only and obtaining the supercritical point of the mixture until the water and/or CO₂ behaves like a liquid and a gas solubilizing the cellulose. An exemplary range may be, for example from 347 to 397° C. (620 to 670 K), for example 647.096 K, and a pressure greater than 22.064 MPa, such as 373° C. and 3200 pounds per square inch gauge (psig). The biomass is processed in batch or continuous mode for a time of 1 sec to 10 sec residence time in one or two stages. The end product is a liquid with short chain polymeric sugars and a solid phase that is lignin. Lignin is separated from the liquid polymeric sugars (FIG. 2, step 9) after saccharification (FIG. 2, step 8).

The hemicellulose stream separated out may be added back to the mixture of cellulose polymeric sugars.

The process equipment may be a reactor or a refiner, an extruder or a reactor that pressurizes and then flashes such as steam explosion. Chemicals or solvents may be used in combination such as alkaline, acid, hydrogen peroxide or ethanol.

Releasing Lignin from the Cannabis Plant or One or More Component Thereof to Form a Lignin-Rich Liquor and a Cellulose-Rich Pulp. Release of lignin from the plant or component(s) may occur prior to undertaking the methods described or may be conducted as a step of the method described. The release can be by mechanical action or by chemical reaction since lignin becomes soluble at higher pH (9-13). Lignin will precipitate if the pH is lowered. The release of lignin is undertaken so as to work with a cellulose-rich pulp fraction in the remainder of the method. Thus, this step involves processing the plant or component(s). In the method described, plant or component(s) may initially be chopped, mashed, crushed or otherwise reduced in preparation for further mechanical degradation. Lignin can be maintained, partially removed, or entirely removed before hydrolysis/saccharification or not removed at all. If it is desirable to remove lignin, this may be done in a first step reaction, by chemical prehydrolysis (FIG. 2, step 6).

Releasing hemicellulose from the Cannabis Plant or One or More Component Thereof to Form a Hemicellulose-Rich Liquor and a Cellulose-Rich Pulp.

Hemicellulose can be extracted from the pretreated substrate by either a chemical agent or by autohydrolysis (no chemical agent) and further processed to high value bioproducts (i.e. xylooligomers, flavonoids) to add back into the beer in a finishing step towards the end of the process.). Mild acids, including but not limited to acetic acid, dilute sulfuric acid, etc. may be used. Temperatures below 100° C. are preferred for this operation, but could be higher if needed. Exemplary conditions might be maintaining temperatures of 20° C. to 200° C. for 1 to 300 minutes. Preferably, the temperature should be between 120 to 190° C., and most preferably 150 to 170° C. The operating conditions can be selected for removal of hemicellulose (no chemicals) or lignin (alkaline conditions). Performing the operating conditions without chemicals (autohydrolysis) leaves a residual cellulose containing lignin, and recovers the hemicellulose fraction as a byproduct, for further use in a later step in making the beer, or optionally for other industrial purposes. Hemicellulose can optionally be removed in part, or entirely, before hydrolysis. This may be advantageous if enzymatic hydrolysis is used, as there may be some inhibitory effect to the enzymes if hemicellulose and/or degraded hemicellulose concentration is too high. In an exemplary embodiment, a significant portion of the hemicellulose (between 20 to 80%) is removed prior to enzymatic hydrolysis preferably 30 to 55%, while much of the lignin and cellulose remain together, with residual hemicellulose content that is not inhibitory to enzyme activity. If it is desirable to remove hemicellulose, this may be done in a first step reaction, either by chemical or autohydrolysis means (FIG. 2, step 4).

Lignin can be maintained, partially removed, or entirely removed before hydrolysis/saccharification or not removed at all.

The cellulose-rich pulp and other polymers may then be hydrolyzed/saccharified, while still in contact with lignin and/or any remaining hemicellulose. Once saccharification/hydrolysis is conducted and carbohydrates are released, then lignin may be separated from the carbohydrate extract.

In step (a), the lignin may be released by reducing the Cannabis plant, to form a lignin-rich liquor and a cellulose-rich pulp. Alternatively, the hemicellulose may be released by reducing the one or more component of the Cannabis plant, to form a hemicellulose-rich liquor and a cellulose-rich pulp. Further, both hemicellulose and lignin could be released, in whole or in part.

Prehydrolysis Reactors

Preparation for the saccharification/hydrolysis step, or prehydrolysis may be conducted in a variety of different ways, such as: by using supercritical CO₂ technology and/or using sub-critical or near-critical water prehydrolysis technology, by using extrusion prehydrolysis, by using hydrothermal prehydrolysis, and thermal mechanical prehydrolysis each of which produces an extract ready for hydrolysis, resulting in carbohydrate-rich stream. The carbohydrate-rich stream can then be utilized either with further processing, such as purification or diluted, for brewing.

Prehydrolysis reactors can be horizontal or vertical, pandia type or other such as digesters and columns, batch and continuous.

The reduced plant or plant component(s) that have been milled, mashed, crushed, chopped, and/or screened or refined to a reduced size are can then be further broken down, for example by feeding such reduced plants or component(s) through a reactor. Such a reactor may be one using mechanical crushing or mashing means, for example an auger or other manner of conveying materials forward within the reactor. Cut, crushed, or mashed plants or component(s) may be fed into a reactor while a liquid washing reagent is fed into the reactor, optionally at an opposing end resulting in a counter-current reaction process. Any variety of reactor may be used. Any reactor that can separate and treat solid biomass may be used. Under appropriate conditions of temperature, pressure, and chemical reagents, the reaction can proceed in different reactor formats. The reactor may be a batch reactor or may have continuous flow. The reactor may be horizontal or vertical in its input/output flow or orientation. U.S. Pat. No. 7,600,707 (Wngerson), describes a Counter Current Reactor which can be used for step 6 FIG. 2.

When a continuous flow reactor with counter-current washing is used, the reactor separates components of a solid biomass feedstock, such as Cannabis plants or component(s). A motorized threaded shaft acts as an auger, extending longitudinally through a number of reaction zones. The zones provide progressive processing regions for the biomass feedstock as it moves through the reactor. A pump provides a fluid into the auger from the terminal end, flowing in an opposite direction to the progress of the biomass.

The reactor may take the form of an extrusion apparatus, where an auger or other comparable force propels the pulp forward, while a liquid solution is pressured through the reactor in the opposite direction (i.e. counter current). Temperature and pressure controls within the reactor advantageously assist with separation and solubilization of lignin within the aqueous phase within the reactor. Alternatively, the reactor may take the form of a tank, for example when batch processing is used.

The fluid used in the mechanical processing within the reactor may be an aqueous solution of appropriate pH, to permit breakdown of biomass materials in the plant or component(s) under the condition required for optimal processing. For example, a basic solution may be employed when high pH is needed in the processing, or an acid may be added to adjust pH downwardly. When a basic solution is needed, for example to break down lignin, sodium hydroxide solution may be used for this step. Other metal hydroxide solutions capable of a similar breakdown may be used. Such solutions may contain sodium hydroxide, potassium hydroxide, magnesium hydroxide, calcium hydroxide, sodium carbonate, lime, magnesium carbonate, ammonia, ammonium-based alkalis or other alkaline or an alkali earth compounds as appropriate to adjust pH.

A variety of different methods may be used to release lignin and/or hemicellulose from the Cannabis plant so that a lignin-rich and/or a hemicellulose-rich liquor can be separated from a cellulose-rich pulp.

Briefly, the method through which a plant or one or more component(s), such as stalks, stems, buds, leaves, flowers, seeds or roots, are broken down to create a separate enriched fraction containing cellulose from a separate fraction rich in lignin and/or hemicellulose involves chemical alteration and washing of biomass material from the plant under elevated pressure and temperature. The plants or component(s) are reduced for processing, such as by chopping, crushing, or mashing into an average thickness of about 1 inch or less, for example, having a thickness of ½ inch, 0.5 inch, or preferably less than about 0.125 inch. The reduced plant or feedstock is provided to a pressured region (or zone) of the reactor. The feedstock is first heated to a temperature of from about 150° C. to about 240° C. For example, from 170 to 220° C., or preferably from 205-215° C., such as 205, 206, 207, 208, 209, 210, 211, 212, 213, 214 or 215° C.

In the case of the above-noted continuous flow reactor, heated feedstock then moves to a different zone of the reactor, for example, through movement of the auger in the counter current reactor described above. Counter-flow of an oxidizing aqueous fluid, such as a hot water wash with an alkaline pH from about pH 8 to 13 is used to create a residual solid component containing cellulose, referenced herein as a cellulose-rich pulp. The filtered wash water containing dissolved materials comprises a lignin-rich liquor. Using this method, the cellulose-rich pulp should contain less than 10% lignin, for example, 9%, 8%, 7%, 6%, 5%, 4%, 3%, 2% or 1%. Lower levels of lignin below 1% lignin may be used when achieving such levels is practical.

Operating conditions can vary, depending on the type of biomass being treated, for example, the age of the plant or component(s) may predict the toughness of the biomass to be processed. Processing times may vary, but from 1 to 20 minutes per zone may be employed. The proportion of pH-adjusted wash water, or aqueous fluid used can vary, but an exemplary range of from 2 to 20 times the dry weight of plant material may be used. In addition to an oxidizer, other chemicals may be introduced as necessary or desired to maintain a pH between about 8 and 13 in the reaction zones.

U.S. Pat. No. 8,057,639 (Andritz Inc.) describes a two stage prehydrolysis process, in this case, a first stage hydrothermal process (FIG. 2, step 4), having a first stage of prehydrolysis carried out by heating the biomass to a first stage temperature of 120° C. to 220° C. (and preferably between 150° C. and 190° C.) for a first stage time of 30 minutes to 3 hours at a first stage pressure of 60 to 190 psig. The reactor may be a Pandia type digester or other, horizontal or vertical, batch or continuous. A catalyst may or may not be added to the first stage prehydrolysis, if used, preferentially sodium hydroxide in a concentration of 1 to 15% w/w of Cannabis biomass in an aqueous solution if lignin removal is desired, or no chemicals if hemicellulose removal is desired. Alternatively, without catalyst, an aqueous/ethanol or aqueous/H₂O₂ mixture can be used where ethanol is in a concentration of 30-70% v/v and H₂O₂ is in a concentration of 10-60% v/v. A second stage reactor can be used on the pulp that has had lignin and/or hemicellulose removed by draining and/or washing. The pulp is pressurized in this reactor to 10 to 15 bar (145-219 psig) followed by flashing (a fast reduction in pressure) to atmospheric pressure to explode or defiber the pulp (FIG. 2, step 6).

A thermomechanical reactor can be used such as that in U.S. Pat. No. 9,580,454 (FPInnovation) such as in FIG. 2, step 6. In this method mechanical refiners use mechanical force and heat to reduce the particle size of the biomass and defiber the pulp in order to expose more surface area for the subsequent treatments including hemicellulose extraction and enzymatic or other saccharification steps for hydrolysis of carbohydrates. The refining is operated at mild conditions using minimum energy input to disintegrate lignocellulosic feedstock and facilitate the separation and fractionation of hemicelluloses, cellulose and lignin in subsequent processes. The refining energy may suitably be 720 to 4320 MJ/t (200 to 1200 kWh/t) and refining pressure of 100 to 600 kPa (1 to 6 bars). Preferably the refining energy and pressure are 1080 MJ/t to 2520 MJ/t (300 to 700 kWh/t) and 200 to 400 kPa (2 to 4 bars), respectively. The refining consistency, the mass percent biomass to water, can be between 20 to 50%.

A wide variety of processes may be used for the breakdown and separation of biomass into a cellulose-rich fraction, so as to release lignin and/or hemicellulose and make the fiber accessible to enzymes. Further details of an alternative process may be found in U.S. Pat. No. 9,567,558 (Suzuki et al.). Any such process that permits the formation and separation of a cellulose-rich pulp from a lignin-rich or hemicellulose-rich liquor may be used.

Optionally A supercritical reactor may be used for the saccharification of cellulose and hemicellulose, by contacting prehydrolyzed pulp with a fluid mixture comprising supercritical carbon dioxide (CO₂) and sub-critical or near-critical water to form a reactant mixture using a temperature of from 300 to 400° C. An exemplary range may be, for example from 340-400° C. This is the super critical prehydrolysis reactor shown on FIG. 2, step 7. This can be two super critical reactors in series. For example, a first reactor for supercritical hydrolysis using CO₂ and a second reactor for sub-critical or near-critical hydrolysis with water and heat and pressure only and obtaining the supercritical point of the mixture until the water and/or CO₂ behaves like a liquid and a gas solubilizing and/or partially solubilizing the cellulose An exemplary range may be, for example from 347 to 397° C. (620 to 670 K), for example 647.096 K, and a pressure greater than 22.064 MPa, such as 373° C. and 3200 pounds per square inch gauge (psig).

The reaction occurs and forms one or more hydrolysis products. The reaction is quenched and dilute acid or enzymes can be used to produce monomers. (U.S. Pat. No. 8,546,560—Renmatix, Inc. King of Prussia, Pa.).

Saccharification: Degrading the Cellulose-Rich Pulp into Carbohydrates.

In step (b) of the steps described herein above (for example parargaph 141), for enzymatic saccharification, food grade enzymes may be used such as food grade cellulases, hemicellulases, xylanases, or other lignocellulose-degrading enzymes. For dilute acid saccharification, the liquid portion is brought to a pH equivalent of a 4% v/v sulfuric acid concentration followed by heating to 120° C. for a period of 30 to 190 minutes, but preferably between 45 and 90 minutes.

In step of (b) of the steps described herein and above (for example paragraph 141), degrading the pulp may occur over 24 to 124 hours. Alternately instead of dilute acid saccharification (or less commonly, as an additional step in addition to dilute acid saccharification) step (b) may involve degradation by one or more cellulase or hemicellulase enzymes, for example from Aspergillus sp., Trichoderma sp., or both. As an example, cellulose- and hemicelluose-degrading enzymes may be produced rom Aspergillus niger and/or Trichoderma reesei. Saccharification or degradation of the pulp may also occur by acid hydrolysis, for example with a weak acid that is able to hydrolyze the bonds of the polymers present in the plant so as to release carbohydrates. The method may comprise separating the carbohydrate extract into a carbohydrate-rich fermentable extract (soluble solids) and a lignin and/or solids rich stream (suspended solids) prior to fermentation.

Once a cellulose-rich pulp is obtained, degrading the polysaccharides such as cellulose and/or hemicellulose into its monosaccharide components is conducted in the presence of enzymes or acids. For enzymatic hydrolysis, following the lignin and/or hemicellulose removal from the pulp, the cellulose-rich pulp, comprising glucans/polysaccharides of D-glucose monomers, linked by glycosidic bonds, undergoes hydrolysis in which the bonds are broken so as to produce glucose. If an enzymatic reaction is used, the enzymatic reaction occurs in an aqueous solution, where pH is controlled, for example using either an acid or base, as required, or other strategies for pH control. The acid may be HCl, H₂SO₄, H₃PO₄, an organic acid, or other acceptable compound or solution of appropriate pH and molarity. The base may be NaOH, KOH, Ca(OH)₂, Mg(OH)₂, NH₄OH, organic base, or other acceptable compound or solution of appropriate pH and molarity. The pH and/or reaction conditions are adjusted to those appropriate for the selected enzyme or cellulose and/or hemicellulose degradation procedure.

Exemplary hydrolysis enzymes, which are ideally of food grade, may be a blend of cellulase and/or hemicellulase enzymes. Food grade enzymes that may be used include, but are not limited to: Attenuzyme Pro, Amylase AG 300 L, Cellucast 1.5 L, Ultraflo Max, Viscozyme L (Novozyme); Cellulase 2000 L, Optimash Barley, Viscamyl Flow (Genencor/DuPont) and Rohalase Barley L, Rohament CEP, Rohalase SEP (ABEnzymes). A similar blend of enzymes of food grade quality may be used. Other cellulose- and hemicellulose-degrading enzymes may be used. In addition to cellulases, other enzymes may be present such as drisealases, laminarinases, endo-glucanases, cellobiohydrolases, beta-glucosidases, xylanases, ligninases, and/or lyticases. Exemplary cellulases may include cellulase from sources such as Aspergillus niger, Aspergillus sp., Trichoderma reesei, (such as from the known and publicly available deposit at ATCC accession number 26921), Trichoderma sp., or cellobiohydrolase I and II from Hypocrea jecorina. Other known cellulase and hemicellulase enzymes mixtures thereof may be employed.

The enzymatic hydrolysis may be run under appropriate conditions for the length of time required for adequate conversion of cellulose and hemicellulose to monosaccharide, for example from 2 to 400 hours, for example from 10 to 120 hours, such as about 48-72 hours.

Optimal conditions to maximize glucose production may vary, depending on batch conditions. Prehydrolysis methodology, temperature, pH, cellulose and hemicellulose loading, enzyme loading are a few variables that may affect appropriate length of time, but do not necessarily represent all possible variables. The optimal conditions specified for the enzyme(s) selected is used to determine the length of the degrading step.

The cellulose-degradation and hemicellulose-degradation step, also referred to as enzymatic saccharification, may be conducted as taught in the literature, such an example is U.S. Pat. No. 9,567,558 or as taught in U.S. Patent Publication No. US2009/0285965 A1.

In embodiments where degradation of hemicellulose is conducted, producing xylose as well as glucose, appropriate enzymes would be used on the fraction that contains hemicellulose. Hemicellulose degradation is conducted with a different enzyme cocktail of appropriate enzymes.

Preparing the Wort for Fermentation

Following saccharification, the soluble carbohydrate fraction is separated from other suspended solid unreactants. Carbohydrate created during the saccharification/hydrolysis step of the method may be separated by any acceptable step that would result in the removal of unwanted components, such as coarse solids. Screening, filtration, centrifugation or decantation, filter press or other may be employed to remove solids and other unwanted reactants.

The fermentable carbohydrate obtained in the saccharification step then goes on to the preparation of a wort (step c of the method), for fermentation and beverage production. An additional step to adjust carbohydrate concentrations may be employed for optimization and consistency from batch-to-batch. The natural products present in the plant or component(s) remain in the product of the saccharification degradation, and can be reduced, adjusted, or selectively enhanced in the carbohydrate fraction of the product (extract or hydrolysate) of the saccharification degradation step.

The carbohydrate fraction is employed in forming a wort. Added components may be included in the wort as desired for flavor or compositional purposes. For example, roasted and/or malted Cannabis seeds and/or hops may be added. Advantageously, hops need not be added, as compared with other beers, as the flavor components of the Cannabis plant can be maintained in the wort. For example, marijuana or hemp flowers and/or leaves may be added in place of hops. Nevertheless, hops may be added to provide the consumer with a familiar flavor, adjusted to approximate conventional beer beverages. Differing types and amounts of hops may be added so as to aid in the production of different styles of beers—such as pilsners, bocks stouts, etc.

The wort is a carbohydrate and/or glucose and/or xylose rich solution created from the product of the hydrolysis step. The concentrated carbohydrate solution from the degradation of cellulose may be filtered and processed further in the wort preparation step. Components present at the termination of the hydrolysis may be maintained or removed as desired.

To form the wort, the carbohydrate fraction (hydrolysis product) may be filtered and used for the wort preparation step. In the wort preparation step, toasted Cannabis seeds, malted Cannabis seeds, and/or hops may be added. Optionally, if desired (or if needed for a source of free amino nitrogen (FAN)), toasted/malted seeds can be steeped into the wort during a heating process that brings the fraction to a desired temperature for a period of time. In one example, the heating process may bring the fraction to 65° C. (150 F) and maintain that temperature for one hour. After one hour, the seeds are removed and the temperature is brought to a boil. The hops are added to the kettle at this point, while the kettle is boiling. Such additives as seeds or hops are added prior to or during the pre-boil step, similar to conventional brewing of beer. In another optional embodiment, if desired, the addition of malted and/or toasted seeds, or other natural flavorings, can be conducted prior to or during the hydrolysis step for enhanced contact time.

Alternatively, in the wort preparation step, toasted barley grains, malted barley seeds, spelt grains and/or malted spelt grains and/or other grains, such as oat, rice, millet, or amaranth may be added. The toasted/malted grains can be steeped into the wort during a heating process that brings the fraction to the boiling point. Such additives as seeds or hops can also be added prior to or during the boil step as described in the immediately preceding paragraph. Further, if desired, the addition of malted and toasted seeds, or other natural flavorings, can be conducted prior to or during the hydrolysis step for enhanced contact time.

In one example, to malt the Cannabis seeds, a source of viable marijuana or hemp seeds is obtained, and malting occurs by starting the germination process. Viable seeds may be malted according to any conventional process. For example, raw seeds are steeped to begin the germination process. Steeping involves floating the seeds, permitting water retention. This step may occur for as long as needed, following which a drying period may occur. Subsequent cycles of steeping and drying may occur until roots begin to grow from the kernel. Once seeds are germinated for an appropriate length of time, the malt is permitted to dry to a low moisture content of about 10% moisture or less. The malt may be finished as desired. The malt used may be purchased, or produced using such other methodologies as are known. The seeds used for the malt may be from a Cannabis plant, such as hemp or marijuana, or may be from different plants, such as barley.

Hops may be included in the wort. In addition to, or as an alternative to hops, a flower from the Cannabis plant, such as the marijuana flower or hemp flower, may be used in the wort. Compounds originating from the marijuana or hemp flowers can be used in an extracted or purified form. Leaves and flowers of Cannabis plants may be used in the process without further purification or extraction. In order for the phytocannaboinids found in the leaves, flower, or oil from the Cannabis plant to impart a psychoactive effect such compounds must be decarboxylated first. Decarboxylation is when the acid form of the compound is converted into the neutral form. In industry, such conversion is commonly accomplished by heating the compounds for a certain period of time at a certain temperature (the minimum temperature and duration may vary according to which compound or subset of compounds is being decarboxylated), although decarboxylation may be accomplished using other means such as exposure to ultraviolet light. Should the phytocannabinoids, or leaves, flower, or oil from the Cannabis plant be added prior to the saccrification or prior to the kettling step (refer to FIG. 2) such compounds will be exposed to sufficient temperatures for sufficient periods to ensure their decarboxylation. Should they be added in a finishing step, they would need to be decarboxylated prior to being infused into the beverage.

The quantity of hops used in the wort can vary, depending on desirable flavors. Similar to the variety of available conventional beers, some consumers enjoy a high level of hops flavors, while others prefer less.

Thus, in some examples, seeds that are malted or toasted, water, and hops, as well as Cannabis leaves, flower, or oil (or phytocannaboinoids in other forms) may be added in the preparation of the wort. The wort is boiled prior to fermentation.

Brewing/fermentation times can also affect the degree to which hops may affect the flavor of the beverage. The length of time of exposure to flavoring components may vary depending on the style of the beer being produced (examples of styles include pilsner, bock, stout, etc.)

The ingredients in the wort may include water, Cannabis, hops, and other natural flavorings, including but not limited to malted barley, fruits, herbs, rice, sugars, etc. In a preferred embodiment, the composition consists of only water, Cannabis and hops, and/or isolates/extracts of these components, without adding ingredients derived from other sources. Ideally, carbohydrates from other plant sources are not added to the wort. Nevertheless, as an alternative, other carbohydrate sources may be accessed, plus an appreciable amount of Cannabis as a contributor to the fermentable carbohydrates. The amount of carbohydrates contributed by the Cannabis plant or component(s), as a percentage of total carbohydrates present in the beverage, may range from 10% to 100%, for example, from 25% to 100%, and preferably 50% or more, 75% or more, or 100% of the carbohydrates are contributed by the Cannabis plant or component(s). For example, some amount of barley or other grains may be included in the wort, and thus, some of the total carbohydrate present may be derived from these sources, which are not derived from Cannabis.

In step (c) of the process described herein and above (for example parargaph 141), free amino nitrogen (FAN) may (and for best results should) be present in an amount of from 100 to 1000 mg/g fermentable carbohydrate in the wort. For example, the wort may comprise FAN at a level of from 300-600 mg/g fermentable carbohydrate. The source of the FAN may be from malted Cannabis seeds, or it may be from product of powdered and hydrolyzed malted hemp seeds.

In a preferred embodiment 100% of the carbohydrate in the wort is derived from Cannabis plant, although it is possible to add or include carbohydrates that are not derived from Cannabis. The carbohydrates present may include glucose, for example at a level of at least about 70% of the carbohydrate in the wort. As another exemplary carbohydrate, xylose may be present, and comprise at least about 15% of the carbohydrate in the wort. Further, the carbohydrates in the wort may optionally comprise a profile such as: glucose at 65 g/L to 150 g/L, such as about 77 g/L; xylose at 10 to 25 g/L, such as about 20 g/L; galactose at 0.1 to 02 g/L, such as about 0.2 g/L; arabinose at 0.01 to 2 g/L %, such as about 0.05 g/L; mannose at 0.1 to 3.0 g/L, such as about 0.5 g/L; and cellobiose at 0.5 to 3 g/L, such as about 1.5 g/L.

The wort may comprise Cannabis seeds, Cannabis flowers, Cannabis leaves, Cannabis oil, hops, or a combination thereof, as well as a wide variety of other components typical or atypical of conventional brewing procedures. For example, when present, Cannabis seeds may be toasted or malted Cannabis seeds. The wort may contain hops. Phytocannabinoids or flavonoids may be added to or present in the wort. The method may involve additional steps of removing or otherwise adjusting the alcohol content of the beverage.

Optional Concentration of the Wort Prior to Fermentation. In some examples, a beverage as described herein may, with certain prehydrolysis reactors, or under certain conditions, or using certain saccharification techniques yield a wort with an inadequate specific gravity, or an inadequate amount of carbohydrates to achieve the desired Alcohol By Volume (ABV) or alcohol percentage. In such cases, the wort may be concentrated using any known concentration technology. Suitable concentration technologies may include: reverse osmosis, evaporation, vacuum rotary evaporation, or lyophilization, amongst many others. Any technique which can concentrate sugars may be used. Such a step is optional and may be perceived as undesirable as it increases the cost of production and may have an impact on flavor profile of the finished product.

Fermenting the Wort to Form the Beverage. Fermentation of the wort may occur according to any known fermentation process, which may be used in preparing conventional beers in the presence of ethanologenic microbes, such as yeast. Traditional brewer's yeast may be used alone, or may be used in combination with other food-grade yeasts not typically used for brewing such as xylose degrading yeasts described herein. The duration of fermentation is determined by the style of beer desired (example pilsner, bock, IPA, etc.).

Microorganism(s) are propagated in a separate step and pitched into fermentation. The microorganism(s) may include freshly propagated as well as recycled microorganism(s). Fermentation can be performed using conventional ale and/or lager yeast, xylose metabolizing yeast or bacteria and using conventional methods or fermentations in series (one after the other spatially separated) where the first stage fermentation uses conventional yeast that produce ethanol from glucose and the second fermentation stage is uses xylose metabolizing yeast that produce ethanol from xylose or alternatively the two or more microorganisms may be combined in co-culture in one fermentation. The fermentation conditions may vary slightly thus two environments may be desired. Lager fermentations typically proceed at temperatures between 12° C.-15° C. (53.6-59° F.) and are pitched at a range of 80 to 120 g microorganism/hl. Ale fermentations typically proceed at temperatures between 15-20° C. (59-68° F.) and are pitched at a range of 50 to 80 g microorganism/hl. The wort is aerated to provide oxygen for propagation and microbial growth prior to flavor formation and alcohol and ester production, predominantly anaerobic and/or facultative anaerobic. Yeast nutrients may be added such as mineral supplementation. Flocculants may be added to promote the separation of microorganisms after fermentation is complete.

The method may occur over any acceptable period of time in which the alcohol is formed, for example between 3 and 28 days, such as for 4 to 10 days. A typical time period may be 4, 5, 6, 7, 8, 9 or 10 days. The acceptable period of time in which the alcohol is formed, may be truncated or reduced for ales and extended for lagers. Following fermentation, aging occurs, and may be permitted to proceed over any appropriate age period, to result in the desired properties. Aging over a period of 3 days to 2 years, such as 3 to 60 days, for example 5, 6, 7, 8 or 9 days may occur. A specialty beverage may be made with an extended aging period of over 60 days, for example 1 year or 2 years.

Fermenting to the desired alcohol content can be controlled at the alcohol production stage, or post-fermentation, by alcohol removal. Control of the alcohol level formed during fermentation is conducted in a manner similar conventional beer brewing, involving control of the carbohydrate content in wort pre-fermentation. As yeast metabolizes the carbohydrate to yield ethanol, the carbohydrate levels and alcohol levels are monitored, such as by monitoring composition density. Further processing may involve steps employed in conventional fermentation processes, such as in the brewing of beer.

Fermentation occurs until the desirable level of characteristics is reached. For those beverages containing alcohol, a level of from 2% to 15% could be achieved, for example from 4% to 10%, or optimally between 5% and 9%, such as for example: 8% alcohol by volume (ABV), or for example at about 8% ABV, as may be desired in an imperial pilsner style of beverage.

Options for Finishing the Beverage. A variety of optional procedures may occur following fermentation, which may be said to “finish” the beverage.

Filtration, clarification, addition of supplemental marijuana oil or phytocannabinoids or terpenes or flavonoids, addition of xylooligimers, addition of certain excipients such as accelerants or decellerants or bioavailability enhancers, removal of alcohol, carbonation, pasteurization, and or bottling, canning or kegging or other packaging of the beverage may occur following the fermentation according to conventional processes, with or without additional finishing procedures.

Alcohol Removal after Fermentation

If desired, alcohol may be removed to a level less than about 0.5% alcohol by volume in the beverage. Further, the step of removing alcohol from the beverage may involve bringing alcohol to a level less than 0.5% alcohol by volume in the beverage, such as removing all or substantially all alcohol from the beverage. Optionally, if desired, the alcohol produced may be recovered, purified and used for extraction of terpenes and cannabinoids from Cannabis.

The step of removal of alcohol may be conducted by any known or acceptable method. Heat is commonly used to evaporate the alcohol, but not the water, which has a higher vaporization point. Heat-based processes for alcohol removal contribute additional effects to the flavor of the beverage. Filtration processes, such as reverse osmosis may be employed to remove the alcohol to create a non-alcoholic beverage. Advantageously, beverages designed to convey an intoxicating effect from marijuana may utilize alcohol removal, such as by reverse osmosis, so that the consumer experiences only the intoxicating effects of the marijuana, but without the additional intoxicating effects of the alcohol.

Addition of phytocannabinoids, terpenes, flavonoids, xylooligimers or xylooligosaccharides or marijuana oil in a finishing step Cannabis oils and/or purified phytocannabinoids added to the beverage beer after alcohol removal Phytocannabinoids, including but not limited to THC, may be added to the beverage, and if it is desirable, the THC level in the beverage may be from about 5.7 to about 57 mg/L (2 to 20 mg/350 ml bottle) and the total phytocannabinoid level in the beverage may be from 8.57 mg/L to 71.4 mg/L (3 to 25 mg/350 ml bottle). If a beverage which conveys psychoactive effects from the Cannabis plant is desired, adding marijuana oil or purified phytocannabinoids at this time could be an alternative to adding Cannabis leaves and/or Cannabis flower and/or Cannabis oil and/or purified cannabinoids in an earlier stage of producing the beer or, if desired this addition could be in addition to adding Cannabis leaves and/or Cannabis flower and/or Cannabis oil and/or purified cannabinoids in an earlier step of the brewing process. Types and levels of phytocannabinoid compounds used will depend on such parameters as desired effect, solubility, and regulatory considerations. The ratios of phytocannabinoids added may be selected to reflect optimal ranges.

A marijuana extract or oil or purified phytocannabinoids may be added to an embodiment of the beverage which already contains phytocannabinoids derived from the addition of marijuana leaves and/or flower, and/or stalks and stems at an earlier step in the process, as appropriate, to adjust levels to the desirable content and/or to have batch-to-batch consistency in the product.

For extracts or oils that are relatively insoluble in the aqueous medium of the beverage, a liposomal carrier or an emulsion may be used. An emulsifier may be added to the oil or extract, or the oil or extract may be formulated in a liposome or liposomal emulsion prior to or during the addition. Other solubilization strategies may be used, such as sonication or shearing to avoid phase separation when insoluble components are added to the beverage. Such an oil or extract can be used to compensate for having differences in THC levels found in marijuana based on different growing seasons or conditions. Including additional phytocannabinoids in the beverage, to supplement naturally occurring phytocannabinoids present from the plant or component(s) thereof can be used as a strategy to achieve a consistent level batch-to-batch consistency in the level of phytocannabinoid present, so that the consumer is able to obtain a consistent product.

Processes Used to Incorporate Excipients in Order to Accelerate the Onset of the Psychoactive Effect of the Phytocannabinoids or to Shorten the Duration of Effect of the Phytocannabinoids in the Beverage.

It may be desired in some embodiments of the beverage described herein that the biological effects, such as psychoactive effects, may be imparted within a relatively short time period post-consumption. Other commercially available beverages which are merely supplemented with Cannabis or phytocannabinoids, can take extended periods of time for intoxicating effects to be realized by the consumer. For such other commercially available beverages it may take up to an hour or more for consumers to feel such an effect. As a result, the consumer may over-consume, in an effort to achieve the desired impact. Thus in certain embodiments of the beverage described herein, it may be desired to add to the beverage in a finishing step either 1) compounds which will accelerate the onset of the effect felt by the consumer of the psychoactive compounds already present in the beverage or 2) marijuana oil or purified phytocannabinoids and/or terpenes and/or flavonoids which have been treated in a process (such as an emulsification) or to which emulsifiers and/or excipients, and or other compounds have been added such that the resulting mixture will, when added to the beverage, create a beverage with an accelerated onset time. Upon consuming a beverage to which the ingredients described in either (1) or (2) of the immediately preceding sentence have been added, a consumer will more quickly realize the bioactive effect, for example, within 5 to 20 minutes of consumption, preferably within 10 minutes or less. Other commercially available Cannabis beverages will keep consumers intoxicated for a very long time—for example for up to 6 hours after consuming a single dose. In some embodiments of the beverage it may be desirable to add to the beverage in a finishing step either 1) compounds which will shorten the duration of the effect felt by the consumer (“deccelerants”) of the psychoactive compounds already present in the beverage or 2) marijuana oil or purified phytocannabinoids and/or terpenes and/or flavonoids which have been treated in a process (such as using certain “nano-technologies”) or to which excipients, and or other compounds have been added such that the resulting mixture will, when added to the beverage, create a beverage with a shortened duration of effect. Upon consuming a beverage to which the ingredients described in either (1) or (2) of the immediately preceding sentence have been added, a consumer will experience a shorter duration of the psychoactive sensation than they would when consuming a similar beverage not treated in this manner.

If desired in certain embodiments of the beverage, xylooligomers, xylooligosaccharides, terpenes, and flavonoids from the Cannabis plant may be added as a finishing step to supplement the levels already in the beverage, or to add to beverages in which none are present, or to maintain batch-to-batch consistency with respect to the levels of such compounds. To the extent that any such compounds will not solubilize in the beverage, emulsifiers, or various solubilization techniques may be used to aid in creating solution or suspension.

Flavoring.

Optionally, the method may involve a step wherein toasted or malted hemp seeds are added for flavoring. Other flavoring compounds, preferably from the Cannabis plant, may be added to the beverage such as the flowers or leaves of the Cannabis plant, or compounds extracted from the trichomes of the Cannabis plant. These may be added to the wort, or at other stages in the process such as during the enzymatic hydrolysis or fermentation steps. Flavorings unrelated to Cannabis plants may be added, for example from citrus, such as lemons, oranges, or grapefruit; from tea, or kombucha, or other natural flavors.

Carbonation and pasteurization. If desired, as finishing steps, the beverage may be carbonated by any known or appropriate means of carbonation or pasteurized using heat or pressure or any known or appropriate means of pasteurization. Pasteurization may occur prior to packaging, or after the product has already been packaged. Pasteurization as used herein is defined as any process applied to a beverage intended to extend its shelf life, for example, by limiting the growth of bacteria. The term “carbonation” typically refers to the introduction of carbon dioxide gas into a liquid. In certain embodiments of the beer (for example in a stout style beer), it may be desirable to introduce nitrogen (or any other gas suitable for consumption in a beverage) instead of carbon dioxide, or in addition to carbon dioxide. The introduction of nitrogen to a beverage for this purpose is sometimes referred to as “nitrogenating”.

Examples of Beverages

A beverage produced according to the methods described is provided herein.

The product described herein may be referred to herein interchangeably as a “beer” or “beverage”, whether or not the beverage contains alcohol.

An intoxicating effect may be associated with an alteration in mood or temperament, for example, which causes a feeling of enjoyment or relaxation, but is not used herein to imply a legal standard, level, or limit.

If an alcohol-containing beverage is desired, the alcohol formed in the fermenting step is maintained in the beverage.

Beverages prepared according to the method which contain alcohol need not contain Cannabis-related psychoactive or bioactive compounds, such as may be derived from marijuana. In the case where it is desired not to have appreciable amounts of psychoactive or bioactive compounds present in the beverage, hemp plants or components (such as stalks, stems, buds, leaves, flowers, seeds, roots etc.) instead of marijuana plants or components thereof may be used in the initial step of the method. Levels of bioactive components in hemp are considerably lower than those found in marijuana plants and are generally considered to be sufficiently low as to render most products made from the stalks, stems, roots, and/or seeds of the hemp plant to be considered ‘nonpsychoactive’. As such these portions of the hemp plant and products made therefrom are not regulated as a controlled substance in most jurisdictions in the world.

For those beverages prepared according to the method which are intended to contain Cannabis-derived bioactive compounds, such as the phytocannabinoids which are found in marijuana in higher concentrations than in hemp, the plant or component(s) used in the method may be from the marijuana plant, or from a combination of both hemp and marijuana plants. Optionally, to achieve such a beverage, plant components comprising stalks, stems, roots and/or flower/leaves and/or seeds of the hemp plant can be used if at some point during the brewing process either a marijuana oil or purified compounds from the marijuana plant are added to impart sufficient bioactive compounds so as to achieve the desired psychoactive effect in the consumer.

For (1) those beverages prepared according to the method which are intended to contain alcohol (for consumers who wish to experience the intoxicating effect of alcohol but not marijuana when consuming the beverage), or for (2) those beverages prepared according to the method which are intended not to contain either bioactive compounds from the Cannabis plant or alcohol (e.g. for consumers who do not wish to experience any intoxicating effect, but who nevertheless wish to consume the beverage) the plant components used in the method may (and preferably should) be from the hemp plant and no supplementation with a marijuana oil or purified phytocannabinoids should be performed.

Non-Alcoholic Beverages. As used herein, the term “non-alcoholic beverage” refers to beverages containing less than 0.5% alcohol by volume (ABV) present in the beverage, for example 0.5%, 0.4%, 0.3%, 0.2%, 0.1%, or undetectable/negligible at 0.05% or less. As applied to beer, the terms “low-alcohol”, “light beer”, “dealcoholized”, “non-alcoholic” and “alcohol-free” refer to products having less alcohol than a conventional beer, with legal definitions varying on a jurisdiction-by-jurisdiction basis. If a non-alcoholic beverage is to be prepared, the beverage is formed according to the method above, but includes the step of (e) removing alcohol from the beverage of step (d) as described herein and above (for example paragraph 141).

Biologically Active Compounds from Cannabis. A beverage that is intended to have biologically effective, or “psychoactive” components derived from the Cannabis plant may be one that is also designed as a non-alcoholic beverage so that the psychoactive effects are not combined with the intoxicating effect of alcohol. Such a beverage, for example a beer, is intended to have a biological effect on the consumer solely using Cannabis-derived compounds, whether such compounds are derived from hemp or from marijuana. A compounded biological effect of alcohol and psychoactive components can be avoided.

The Cannabis-derived compounds may comprise biologically active alkaloids such as phytocannabinoids, and terpenes, flavonoids, or other natural compounds derived from the Cannabis plant. Isolated compounds derived from Cannabis may be added at different stages of the process, such as when preparing the wort, or before or after fermentation. Further, for the beverages in which the additional step of removing the alcohol is conducted, biologically active compounds isolated from Cannabis plants may be added to the beverage following removal of alcohol. Compounds such as isolated phytocannabinoids, terpenes and/or flavonoids could be added before, during or following the wort preparation, the fermentation step, or the optional alcohol removal step.

Certain phytocannabinoids will have no impact on a consumer's mood or temperament, and are said not to have psychoactive or intoxicating effects, even if the compound is considered to be a bioactive compound due to other suspected or proven biological effects, such as on pain tolerance or appetite stimulation.

An exemplary marijuana-free alcohol-containing product may be produced with a THC content that is negligible, and below 0.03 mg/L so as to impart negligible psychoactive effects. Similarly, an exemplary level of CBD in a marijuana-free alcohol-containing product may be below 0.03 mg/L, but may also be present at a slightly higher level, owing to the non-psychoactive effect of CBD. The beverage can be designed to comply with jurisdictional regulatory requirements, and specifically to comply with regulations applicable to beverages containing CBD.

A non-alcoholic marijuana-containing product, where permitted on a jurisdictional basis, may have a THC level of about 5.7 to about 57 mg/L (2 to 20 mg/350 ml bottle) and the total phytocannabinoid level in the beverage may be from 8.57 mg/L to 71.4 mg/L (3 to 25 mg/350 ml bottle). The amount of THC and CBD and/or any other phytocannabinoid present could be selected independently, and can be adjusted so that any particular phytocannabinoid is present and any other phytocannabinoid is absent.

Products Produced. The following four types of products may be made according to the method described.

(1) A beverage which intoxicates due to the alcohol content, but does not contain appreciable amounts of psychoactive phytocannabinoids. Such a product has no intoxicating effect attributable to Cannabis or marijuana, but is prepared according to the method described.

(2) A beverage which does not contain alcohol and is not intoxicating to the consumer in any way. Such a product does not contain appreciable amounts of phytocannabinoids. Such a beverage is brewed according to the described method, but the alcohol has been removed.

(3) A beverage which does not contain alcohol, but which intoxicates using marijuana-derived compounds, such as phytocannabinoids from the marijuana plant. Optionally, such a beverage may include a biologically active excipient to shorten the onset time of the intoxicating effects of the compounds, and/or an excipient to shorten the duration of the intoxicating effect.

(4) A beverage which contains both alcohol and marijuana and/or psychoactive compounds from the marijuana plant, both of which can contribute an intoxicating effect.

Free Amino Nitrogen (FAN)

Along with a carbon source, yeast cells require a nitrogen source.

Other than sugar, nitrogen is probably the most important macronutrient required for yeast health and growth. Nitrogen deficiency is associated with several fermentation difficulties including stuck and incomplete fermentations, whereas excess nitrogen is related to the production of both off flavours and beer spoilage.

Nitrogen is often assessed by measuring Free Amino Nitrogen (FAN). Together with ammonia, FAN makes up what is known as Yeast Assimilable Nitrogen or YAN. FAN compounds are formed naturally during malting and mashing by the action of protein degradation enzymes on protein found in the grain or seed in the case of this method. The level of amino acids available in the wort relies on several variables including grain/seed variety, as well as malting and mashing conditions, but the overall types of amino acids available will be similar among similar grains or seeds. The specific amino acids taken up by yeast follow a similar pattern during fermentation, although environmental changes can alter this.

Studies appear to have resulted a general belief that a minimum level of 150 mg/L FAN is required for complete fermentation, with 200-250 mg/L being seen as ideal. However more recent data suggest wort FAN levels might need to be higher, especially in some higher ABV beers. Excess FAN levels lead to haze production and off flavours, such as diacetyl, or higher alcohols like isoamyl alcohol, propanol, and isobutanol. These alcohols can cause alcohol heat in the finished product.

The brewing conducted using the wort, according to the process, may use conventional Brewer's yeast, or may use a specialized or unconventional blend or strain of yeast, thereby permitting fermentation of carbohydrates other than glucose, such as xylose and other carbohydrates.

Yeast used for brewing may assimilate ammonium ions, however they culture faster and produce a higher quality beer with better organoleptic properties when amino acids are used as nitrogen source. Amino acids taken up by yeast, which are not directly utilized for protein synthesis, may either be stored within the cell or further metabolized through catabolic processes. When amino acids enter the cell, their amino groups are removed by a transaminase system and their carbon skeletons assimilated into oxo-acids (keto acids). Fusel alcohols, which contribute to the beer's organoleptic qualities, are formed from amino acid uptake and catabolism. There have been over 40 alcohols identified in beer.

The protein portion of hemp and/or marijuana (found most prevalently in the seeds) is different from barley and other plants in its composition of amino acids. Furthermore, hemp and/or marijuana seeds are of great nutritional value, containing all essential amino acids and fatty acids. Hemp and/or marijuana have high-contents of omega-3 fatty acids. Free amino acids can be obtained from hemp seeds by germinating or malting them. Alternatively, free amino nitrogen can be generated from hemp and/or marijuana seeds by grinding them to a powder and hydrolyzing them with mild acid.

To ensure that sufficient FAN is present in the wort for an optimal fermentation, malted hemp and/or marijuana seeds may be added to the wort, or the result of a process wherein hemp and/or marijuana seeds are ground to a powder and hydrolyzed may be added to the wort.

The FAN utilized in the process described hereinto may be present in amounts ranging from 100-1000 mg/g fermentable carbohydrate in the wort, for example, 300-600 mg/g fermentable carbohydrate, when proceeding through hydrolysis or malting.

Xylose in Beer

Lignocellulose, hemicellulose, cellulose and xylose are not conventionally used in fermented beverages. Wort made from barley does not contain appreciable amounts of xylose as a monomeric carbohydrate. Most of the xylose present in wheat or barley is joined into larger molecules with arabinose, another pentose sugar. Together they are referred to as “arabinoxylan”. This polymer usually consists of roughly equal parts xylose and arabinose and can constitute up to 10% of brewing grains. This polymer remains largely unused and is left behind in the “spent grains”. Most arabinoxylan is not soluble and will remain in the spent grain following the mashing step. However, 1-2 g/l arabinoxylan may be found in a typical hopped wort and effects the wort's viscosity. Some of the simpler arabinoxylooligosaccharides created by breakdown of the arabinoxylans are found in beer, anywhere from 0.8 to 2 g/l (Courtin et al., 2009). These polysaccharides can affect the mouthfeel of a beer, giving roundness, and are generally considered taste-neutral.

Typical yeast strains used in brewing do not ferment xylose, and so if any xylose were present in the wort, it would not be fermented in conventional brewing. Yeast strains that are not typical of the brewing process may be used, for example so as to permit xylose to be fermented and obtain a dry beer, low in residual carbohydrates.

Xylose Metabolizing Yeast.

A standard/conventional beer may have no more than 4% by weight residual carbohydrates. Such a standard beer is made from grains. Gluten-free beers can be made from sorghum or other carbohydrates (including grains which do not contain carbohydrates).

Natural xylose-metabolizing yeast such as Candida shehatae, K. marxianus, Pichia stipitis, Pachysolen tannophilus, Scheffersomyces stipites, D. hansenii and some strains of P. kudriavzevii can ferment xylose, and thus may be used in the process described herein for brewing the described beverage. Importantly care should be taken to only select those xylose-metabolizing yeast which will produce approved drinking alcohols and/or pleasant tasting alcohol when converting xylose into alcohol.

Xylooligosaccharides

Hemicellulose refers to several amorphous polysaccharides found in the plant cell-wall matrix that have β-(1-4)-linked backbones, which are commonly categorized into several groups such as xyloglucans, heteroxylans, (galacto) glucomannans, and arabinogalactans (Shallom and Shoham 2003). In the hydrolysis of hemp and/or marijuana stalk and stem, hemicellulose is broken down into oligosaccharides of varying degrees of polymerization. These are also referred to as “xylooligosaccharides”. The xylooligomers formed from hemicellulose act as prebiotics in the human digestive system since the gut microbes can metabolize them as food, whereas humans cannot. Such potentially beneficial compounds described in this paragraph are generally not found in beers, or if they are it is just in trace amounts. In the beer produced following the Method described herein, such potentially beneficial compounds may be found in large quantities.

In optimal embodiments of the method described herein, care may be taken to maintain (or in some embodiments increase) the level of xylooligosaccharides and/or xylooligomers in the final beverage as it may have a beneficial prebiotic function in the consumer.

Plant Sterols

Certain plant sterols (phytosterols) are known to inhibit the absorption of dietary cholesterol by the human body, and there are now several commercially available food products that contain these phytosterols. Barley malt, yeast and hops also contain phytosterols or similar materials that might potentially act as inhibitors of cholesterol uptake, but this effect has not been studied. Standard beers normally contain very low levels of either sitosterol or ergosterol, although some wheat beers that contain high levels of yeast may contain elevated levels of ergosterol. The amounts of plant sterols in the beers produced using the method described herein is considerably higher than in standard beers.

Phenolics

Lignocellulose is hydrolysed in the method described herein, and residual amounts of lignin may remain in the beverage. Beer produced from Cannabis is likely to have a higher phenolic composition than a beer that is produced from other grains.

Ferulic acid is the most abundant phenolic acid in conventional beers, followed by sinapic, vanillic, caffeic, p-coumaric, and 4-hydroxyphenylacetic acids. Ferulic, caffeic, syringic, sinapic, and, to a lesser extent, vanillic acids are present in beers mainly as bound forms, whereas p-coumaric and 4-hydroxyphenylacetic acids are generally present equally in free and bound forms. Total polyphenols and phenolic acids contents greatly vary among different beer types (i.e., total polyphenols, from about 300 μg/mL gallic acid equivalents for dealcoholized beers to 800 or more μg/mL gallic acid equivalents for bock beers, with higher values measured in bock, abbey, and ale beers and lower values in dealcoholized beers) (Piazzon et al. 2010).

One of the concerns with producing carbohydrates from lignocellulose is that severe operating conditions can lead to carbohydrate degradation products and by-products of ligninF break down that can be inhibitory to the yeast. The wort produced by example 8 was analyzed for the following (furfural, 5-hydrolxymethyfurfural (5-HMF), formic acid, levulinic acid, ferulic acid, p-coumaric acid, guaiacol, trans-cinnamic acid, vanillic acid. None of these compounds were detected. Analysis was performed according to NREL protocol 42623 at Loyalist College, Belleville, ON, Canada.

Unique Chemical Composition of Hemp Beer Made from Stalk and Stem

The sprouting of hemp and/or marijuana seeds can induce the production of the anti-inflammatory prenylflavonoids cannflavins A and B. Flavonoids are quite abundant in nature, while prenylated flavonoids are much less common. Greater than twenty-five flavonoids have been isolated from Cannabis, representing seven chemical structures (vitexin, isovitexin, apigenin, luteolin, kaempferol, orientin and quercetin) with different glycosylation, prenylation, geranylation and methylation patterns.

As per Example 8 below, analysis of initial feed Cannabis for use in the method of beverage preparation was performed (in this case the initial feed Cannabis was hemp, although very similar results would be expected for most strains of marijuana), and the carbohydrate profile was as follows (as a percentage of the total suspended solids on a dry basis): Extractives—2.92%, Lignin—19.01%, Glucan—46.68%, Xylan—14.59%, Galactan—1.3%, Arabinan—0.45%, Mannan—2.90%, When glucan, xylan, galactan arabinan and mannan are considered as adding to 100% to create a carbohydrate profile, these percentage values are as follows: glucan 70.6%; xylan 22.1%; galactan, 2%; arabinan 0.7%; and mannan: 4.3%. See Table 1 (NREL protocols: 42621, 42618, 42622 and Dionex HPLC system, Innofibre, Trois Riviere, QC, Canada)

Table 1 shows feed Cannabis composition as a percentage of total suspended solids on a w/w dry basis before prehydrolysis.

TABLE 1
Hemp composition before prehydrolysis

| Extractives | Lignin | Arabinan | Galactan | Glucan | Mannan | Xylan |
|---|---|---|---|---|---|---|
| % | % | % | % | % | % | % |
| 2.92 | 19.01 | 0.45 | 1.30 | 46.68 | 2.90 | 14.59 |

The ratio of glucose to the total of [xylose+galactose+mannose] combined (or “XGM”) was found to be: 3.72:1 in the feed Cannabis (hemp). The column and conditions were conducted according to NREL protocols: 42621, 42618, 42622 and on a Dionex HPLC system. Analysis was performed at Innofibre in Trois Riviere, QC, Canada.

As per Example 8 below, carbohydrate analysis of Cannabis biomass for use in the method of beverage preparation was performed after prehydrolysis but before enzymatic hydrolysis, and the carbohydrate profile was as follows as a percentage of the total suspended solids on a dry basis: Glucan—50.51%, Xylan—15.03%, Galactan—1.15%, Arabinan—0.46%, Mannan—2.74%. When glucan, xylan, galactan, arabinan and mannan are considered as adding to 100% to create a carbohydrate profile, these percentage values are as follows: glucan 72.27%; xylan 21.51%; galactan, 1.65%; arabinan 0.66%; and mannan: 3.92%. See Table 2. (The column and conditions were conducted according to NREL protocols: 42621, 42618, 42622 and on a Dionex HPLC carbohydrate system. Analysis was performed at Innofibre in Trois Riviere, QC, Canada.) The amounts of galactose and mannose are relatively minor contributors. When evaluated as a percent of total carbohydrates by weight, the above-noted carbohydrates of Table 2 have the following values: arabinose: 0.5%; galactose 0.2%; glucose: 77.6%; mannose: 0.45%; xylose: 20.2%; and cellobiose: 1.6%.

TABLE 2
cannabis composition after prehydrolysis as a percentage of the total suspended solids
Hemp composition after prehydrolysis and before enzymatic hydrolysis

| Extractives | Lignin | Arabinan | Galactan | Glucan | Mannan | Xylan |
|---|---|---|---|---|---|---|
| % w/w | % w/w | % w/w | % w/w | % w/w | % w/w | % w/w |
| 3.31 | 18.93 | 0.46 | 1.15 | 50.51 | 2.74 | 15.03 |

Table 3 shows carbohydrate content of total dissolved solids in concentration units of gram sugar per litre solution after enzymatic hydrolysis

TABLE 3
Carbohydrate Content after 96 hr in Enzymatic Hydrolysis

| | | | | | | Total |
|---|---|---|---|---|---|---|
| Arabinose | Galactose | Glucose | Mannose | Xylose | Cellobiose | Carbohydrates |
| g/L | g/L | g/L | g/L | g/L | g/L | g/L |
| 0.031 | 0.105 | 40.652 | 0.236 | 10.576 | 0.824 | 52.40 |

As per Example 8 below, a high yield of ethanol was obtained from glucose in the process described (0.50 g ethanol/g glucose), indicating no toxicity or toxic effect of the hemp extract to the yeast.

In this exemplary batch, xylose was not metabolized to alcohol, and the beverage produced contained about 5.9% alcohol content, by volume. Other batches made using different parameters could produce higher or lower alcohol contents. In instances when it is desirable, yeasts capable of fermenting xylose may be used in the brewing process, and could render a higher alcohol content, as well as lower the sweetness of the beverage so produced.

Scale. Specific details are not provided as to whether the embodiments described herein are implemented on a small or large scale. The methods may be implemented on a small laboratory scale, a test pilot scale, a pilot plant scale, or a commercial scale, or a combination thereof. The methods described may be adjusted to be scaled up or scaled down to any desired capacity.

Automation. Embodiments of the disclosure can be conducted by automation directed by a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to direct equipment that may perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device and can interface with circuitry to perform the described tasks.

### EXAMPLES

### Example 1: Prehydrolysis Using a Thermomechanical/Chemical Extrusion Reactor. Alcohol Beverage Brewed from Hemp and Intoxicates Due to Alcohol Content with No Appreciable Phytocannabinoid Content

Hemp stalks and stems were obtained without leaves, buds and/or seeds. Hemp plant components were screened to remove dirt, sand, contaminants and chopped to about ½ inch pieces (FIG. 2, steps 1, 2), and presoaked (FIG. 2, step 3) prior to processing in a continuous thermomechanical/chemical countercurrent prehydrolysis reactor at 208° C. together with an aqueous solution of sodium hydroxide, at a concentration to achieve a pH of 11, which flows counter-current to biomass movement (FIG. 2, step 5). In this way a lignin-rich and/or hemicellulose-rich liquor was produced and separated from the cellulose-rich pulp by particle size exclusion and regional pressure variations. A reactor such as described in U.S. Pat. No. 7,600,707 was used, although the resulting product could have been made with other reactors as well.

The cellulose-rich pulp was directed to a saccharification step (FIG. 2, step 7) where enzymatic hydrolysis proceeds for 72 hours in the presence of cellulose-degrading and hemicellulose-degrading enzymes provided by Cellic CTec3 from Novozyme (Franklin, N.C., USA). Other enzymes could have been used instead with similar or identical results. For example, food grade enzymes could have been used. The cellulose-rich pulp contains lignin and hemicellulose, and some or portions of these were removed, as desired. For example, it was found to be desirable to remove hemicellulose prior to an enzymatic hydrolysis.

The pulp solids were washed by the counter current functionality of the reactor simultaneously to mechanical defibration. Following saccharification, the remaining solid fraction was removed, and the carbohydrate fraction was mixed with toasted hemp seeds to form a wort (FIG. 2, step 10).

After mashing and lautering at 65° C. for 60 minutes (FIG. 2, step 10), the seeds were separated (FIG. 2, step 11) and the extract was moved to the kettle where hops were added and the liquid brought to a temperature of 90-100° C. for a period of 60 minutes (FIG. 2, step 12). The wort was cooled, trub solids separated out in steps 12 and 13 respectively and the wort was concentrated to obtain a fermentable carbohydrate concentration of 135 g/L glucose (FIG. 2 step 15). The wort was aerated and brewer's yeast with xylose metabolizing ethanogenic yeast were added and fermentation of the wort occurred over 7-21 days until an 8% alcohol content is achieved. The beverage was filtered, aged for 5-10 days, carbonated and bottled. The beverage contained alcohol, but an undetectable amount of phytocannabinoids such as THC or CBD. The beer was pasteurized in the bottles.

### Example 2: Prehydrolysis Using Thermomechanical/Chemical Extrusion Reactor. Non-Alcoholic Beverage from Marijuana Stems and Stalks with Added Marijuana Oil. Intoxicates Due to Phytocannabinoid Content

Marijuana stalks and stems are obtained without leaves, buds and/or seeds. Marijuana plant components are screened to remove dirt, sand, contaminants and chopped to about ⅛ inch pieces (FIG. 2, steps 1, 2), with no presoaking (FIG. 2, step 3) prior to processing in a continuous thermomechanical/chemical countercurrent prehydrolysis reactor at 195° C. together with an aqueous solution of sodium hydroxide, at a concentration to achieve a pH of 11 which flows counter-current to biomass movement (FIG. 2, step 5). In this way a lignin-rich and/or hemicellulose-rich liquor is produced and separated from the cellulose-rich pulp by particle size exclusion and regional pressure variations. Optionally, a reactor such as described in U.S. Pat. No. 7,600,707 may be used.

The cellulose-rich pulp is directed to a saccharification step (FIG. 2, step 7) where enzymatic hydrolysis proceeds for 72 hours in the presence of cellulose-degrading and hemicellulose-degrading enzymes provided by Cellic CTec3 from Novozyme (Franklin, N.C., USA). Other enzymes could be used. For example, food grade enzymes could be used. The cellulose-rich pulp contains lignin and hemicellulose, and some or portions of these may be removed, as desired. For example, it may be desirable to remove hemicellulose prior to an enzymatic hydrolysis.

The pulp solids are washed by the counter current functionality of the reactor simultaneously to mechanical defibration. Following saccharification, the remaining solid fraction is removed, and the carbohydrate fraction is mixed with malted and toasted marijuana seeds to form a wort (FIG. 2, step 10).

After mashing and lautering at 65° C. for 60 minutes (FIG. 2, step 10), the seeds are separated (FIG. 2, step 11) and the extract is moved to the kettle where hops are optionally added and the liquid brought to a temperature of 90-100° C. for a period of 60 minutes (FIG. 2, step 12). The wort is cooled, trub solids separated out in steps 12 and 13 respectively and the wort is concentrated to obtain a fermentable carbohydrate concentration of 135 g/L glucose (FIG. 2 step 15). The wort is aerated and brewer's yeast with xylose metabolizing ethanogenic yeast are added and fermentation of the wort occurs over 7-21 days until an 8% alcohol content is achieved. The beverage is filtered, aged for 5-10 days,

The beer is analyzed for phytocannabinoid content so it may be determined how much marijuana oil must be added to achieve the desired phytocannabinoid content in the final beverage. The filtered beverage is directed to a reverse osmosis process for removal of alcohol using a polyamide membrane under pressure at about 10° C., and alcohol removal proceeds to less than 0.05% alcohol by volume in the finished beverage.

Marijuana oil is added to the beverage in a liposomal emulsion or other hydrophobic and/or hydrophilic emulsion to bring the THC level to 17 mg/L.

The beverage is carbonated and pasteurized.

The beverage has a detectable amount of phytocannabinoids such as THC and CBD.

### Example 3: Prehydrolysis Using Thermomechanical/Chemical Extrusion Reactor. Non-Alcoholic Beverage from Hemp and Marijuana Plants to which Psychoactive Compounds from the Marijuana Plant are Added

Marijuana and hemp stalks and stems are obtained. The plants comprise about 50% hemp and 50% marijuana. The plants are obtained with buds removed but with mature leaves and seeds remaining.

Marijuana plant components are screened to remove dirt, sand, contaminants and chopped to about ¼ inch pieces (FIG. 2, steps 1, 2) with no presoaking (FIG. 2, step 3) prior to processing in a continuous thermomechanical/chemical countercurrent prehydrolysis reactor at 208° C. together with an aqueous solution of sodium hydroxide, at a concentration to achieve a pH of 11 which flows counter-current to biomass movement (FIG. 2, step 5). In this way a lignin-rich and/or hemicellulose-rich liquor was produced and separated from the cellulose-rich pulp by particle size exclusion and regional pressure variations. Optionally, a reactor such as described in U.S. Pat. No. 7,600,707 may be used.

The cellulose-rich pulp is directed to a saccharification step (FIG. 2, step 7) where enzymatic hydrolysis proceeds for 72 hours in the presence of cellulose-degrading and hemicellulose-degrading enzymes provided by Cellic CTec3 from Novozyme (Franklin, N.C., USA). Other enzymes could be used. For example, food grade enzymes could be used. The cellulose-rich pulp contains lignin and hemicellulose, and some or portions of these may be removed, as desired. For example, it may be desirable to remove hemicellulose prior to an enzymatic hydrolysis.

The pulp solids are washed by the counter current functionality of the reactor simultaneously to mechanical defibration. Following saccharification, the remaining solid fraction is removed, and the carbohydrate fraction is mixed with malted and toasted marijuana seeds to form a wort (FIG. 2, step 10).

After mashing and lautering at 65° C. for 60 minutes (FIG. 2, step 10), the seeds are separated (FIG. 2, step 11) and the extract is moved to the kettle where hops are optionally added and the liquid brought to a temperature of 90-100° C. for a period of 60 minutes (FIG. 2, step 12). The wort is cooled, trub solids separated out in steps 12 and 13 respectively and the wort is concentrated to obtain a fermentable carbohydrate concentration of 135 g/L glucose (FIG. 2 step 15). The wort is aerated and brewer's yeast with xylose metabolizing ethanogenic yeast are added and fermentation of the wort occurs over 7-21 days until an 8% alcohol content is achieved. The beverage is filtered, aged for 5-10 days,

The beer is analyzed for phytocannabinoid content so it may be determined how much marijuana oil must be added to achieve the desired phytocannabinoid content in the final beverage . . . The filtered beverage is directed to a reverse osmosis process for removal of alcohol using a polyamide membrane under pressure at about 10° C., and alcohol removal proceeds to less than 0.05% alcohol by volume in the finished beverage.

A marijuana oil consisting of a combination of psychoactive compounds and terpenes derived from the marijuana leaves and/or flowers is then added to the beverage in a liposomal emulsion or other hydrophobic/hydrophilic emulsion to bring the THC level to 15 mg/L. The beverage is considered non-alcoholic and has a detectable amount of phytocannabinoids including THC. The beverage is further aged for 8 days, carbonated and bottled.

The beverage has a detectable amount of phytocannabinoids such as THC and CBD. The beer is pasteurized in the bottles.

### Example 4: Prehydrolysis Using Thermomechanical/Chemical Extrusion Reactor. A Beer which Intoxicates Due to the Alcohol Content, but does not Contain Appreciable Amounts of Phytocannabinoids

Hemp stalks, stems and/or roots are obtained without leaves, buds and/or seeds. Hemp plant components are screened to remove dirt, sand, contaminants and chopped to about ½ inch pieces (FIG. 2, steps 1, 2) and was presoaked (FIG. 2, step 3) prior to processing in a continuous thermomechanical/chemical countercurrent prehydrolysis reactor at 210° C. together with an aqueous solution of sodium hydroxide, at a concentration to achieve a pH of 11 which flows counter-current to biomass movement (FIG. 2, step 5). In this way a lignin-rich and/or hemicellulose-rich liquor is produced and separated from the cellulose-rich pulp by particle size exclusion and regional pressure variations. Optionally, a reactor such as described in U.S. Pat. No. 7,600,707 may be used.

The cellulose-rich pulp is directed to a saccharification step (FIG. 2, step 7) where enzymatic hydrolysis proceeds for 68 hours in the presence of cellulose-degrading and hemicellulose-degrading enzymes provided by Cellic CTec3 from Novozyme (Franklin, N.C., USA). Other enzymes could be used. For example, food grade enzymes could be used. The cellulose-rich pulp contains lignin and hemicellulose, and some or portions of these may be removed, as desired. For example, it may be desirable to remove hemicellulose prior to an enzymatic hydrolysis.

The pulp solids are washed by the counter current functionality of the reactor simultaneously to mechanical defibration. Following saccharification, the remaining solid fraction is removed, and the carbohydrate fraction is mixed with malted and toasted hemp seeds to form a wort (FIG. 2, step 10).

After mashing and lautering at 65° C. for 60 minutes (FIG. 2, step 10) the seeds are separated (FIG. 2, step 11) and the extract is moved to the kettle where hops are optionally added and the liquid brought to a temperature of 90-100° C. for a period of 60 minutes (FIG. 2, step 12). The wort is cooled, trub solids separated out in steps 12 and 13 respectively and the wort is concentrated to obtain a fermentable carbohydrate concentration of 75 g/L glucose (FIG. 2 step 15). The wort is aerated and brewer's yeast with xylose metabolizing ethanogenic yeast are added and fermentation of the wort occurs over 7-21 days until an 5% alcohol content is achieved. The beverage is filtered, aged for 5-10 days, carbonated and bottled. The beverage contains alcohol, but an undetectable amount of phytocannabinoids such as THC or CBD. The beer may be pasteurized in the bottles.

### Example 5: Prehydrolysis Using Thermomechanical/Chemical Extrusion Reactor. Non-Alcoholic Beverage with No Intoxicating Phytocannabinoids

Hemp stalks and stems are obtained without leaves, buds and/or seeds. Hemp plant components are screened to remove dirt, sand, contaminants and chopped to about ½ inch pieces (FIG. 2, steps 1, 2) and was presoaked (FIG. 2, step 3) prior to processing in a continuous thermomechanical/chemical countercurrent prehydrolysis reactor at 208° C. together with an aqueous solution of sodium hydroxide, at a concentration to achieve a pH of 11 which flows counter-current to biomass movement (FIG. 2, step 5). In this way a lignin-rich and/or hemicellulose-rich liquor is produced and separated from the cellulose-rich pulp by particle size exclusion and regional pressure variations. Optionally, a reactor such as described in U.S. Pat. No. 7,600,707 may be used.

The cellulose-rich pulp is directed to a saccharification step (FIG. 2, step 7) where enzymatic hydrolysis proceeds for hours in the presence of cellulose-degrading and hemicellulose-degrading enzymes provided by Cellic CTec3 from Novozyme (Franklin, N.C., USA). Other enzymes could be used. For example, food grade enzymes could be used. The cellulose-rich pulp contains lignin and hemicellulose, and some or portions of these may be removed, as desired. For example, it may be desirable to remove hemicellulose prior to an enzymatic hydrolysis.

The pulp solids are washed by the counter current functionality of the reactor simultaneously to mechanical defibration. Following saccharification, the remaining solid fraction is removed, and the carbohydrate fraction is mixed with malted and toasted hemp seeds to form a wort (FIG. 2, step 10).

After mashing and lautering at 65 for 60 minutes (FIG. 2, step 10) the seeds are separated (FIG. 2, step 11) and the extract is moved to the kettle where hops are optionally added and the liquid brought to a temperature of 90-100° C. for a period of 60 minutes (FIG. 2, step 12). The wort is cooled, trub solids separated out in steps 12 and 13 respectively and the wort is concentrated to obtain a fermentable carbohydrate concentration of 135 g/L glucose (FIG. 2 step 15). The wort is aerated and brewer's yeast with xylose metabolizing ethanogenic yeast are added and fermentation of the wort occurs over 7-21 days until an 8% alcohol content is achieved. The beverage is filtered, aged for 5-10 days, carbonated and bottled.

The beverage has negligible amounts of phytocannabinoids such as THC and CBD, and no intoxicating effect on the consumer.

### Example 6: Prehydrolysis Using Thermomechanical/Chemical Extrusion. Non-Alcoholic Beverage Containing Phytocannabinoids Derived from Leaves and Flowers

Hemp stalks and stems are obtained without leaves, buds and/or seeds. Hemp plant are screened to remove dirt, sand, contaminants and chopped to about ½ inch pieces (FIG. 2, steps 1, 2) and was presoaked (FIG. 2, step 3) prior to processing in a continuous thermomechanical/chemical countercurrent prehydrolysis reactor at 206° C. together with an aqueous solution of sodium hydroxide, at a concentration to achieve a pH of 11 which flows counter-current to biomass movement (FIG. 2, step 5). In this way a lignin-rich and/or hemicellulose-rich liquor is produced and separated from the cellulose-rich pulp by particle size exclusion and regional pressure variations. Optionally, a reactor such as described in U.S. Pat. No. 7,600,707 may be used.

The cellulose-rich pulp is directed to a saccharification step (FIG. 2, step 7) where enzymatic hydrolysis proceeds for 72 hours in the presence of cellulose-degrading and hemicellulose-degrading enzymes provided by Cellic CTec3 from Novozyme (Franklin, N.C., USA). Other enzymes could be used. For example, food grade enzymes could be used. The cellulose-rich pulp contains lignin and hemicellulose, and some or portions of these may be removed, as desired. For example, it may be desirable to remove hemicellulose prior to an enzymatic hydrolysis.

The pulp solids are washed by the counter current functionality of the reactor simultaneously to mechanical defibration. Following saccharification, the remaining solid fraction is removed, and the carbohydrate fraction is mixed with malted and/or toasted hemp seeds and marijuana leaves and flowers to form a wort (FIG. 2, step 10).

After mashing and lautering at 65° C. for 60 minutes (FIG. 2, step 10), the seeds are separated (FIG. 2, step 11) and the extract is moved to the kettle where hops are optionally added and the liquid brought to a temperature of 90-100° C. for a period of 60 minutes (FIG. 2, step 12). The wort is cooled, trub solids separated out in steps 12 and 13 respectively and the wort is concentrated to obtain a fermentable carbohydrate concentration of 135 g/L glucose (FIG. 2 step 15). The wort is aerated and brewer's yeast with xylose metabolizing ethanogenic yeast are added and fermentation of the wort occurs over 7-21 days until an 8% alcohol content is achieved. The beverage is filtered, aged for 5-10 days, The filtered beverage is directed to a reverse osmosis process for removal of alcohol using a polyamide membrane under pressure at about 10° C., and alcohol removal proceeds to about 0.05% alcohol by volume in the finished beverage.

Phytocannabinoids such as THC are measured. THC and other phytocannabinoids are present in the beverage with a profile comparable to the marijuana leaves found in the plant starting material, without the need to add marijuana oil or purified compounds from the marijuana plant to the beverage. An emulsifier or other technology may be added to ensure phytocannabinoids stay in suspension. An accelerant technology may be added if desired. The target THC is 6 mg per 341 ml bottle. The beverage is aged for 13 days and bottled. The beverage is considered non-alcoholic, and has a detectable amount of THC and CBD.

### Example 7 Prehydrolysis Using Thermomechanical/Chemical Extrusion. Alcoholic Beverage with Marijuana-Derived Psychoactive Effects

Hemp and marijuana stalks, stems and roots are obtained with leaves and seeds remaining. The plant components are screened to remove dirt, sand, contaminants and chopped to about ½ inch pieces (FIG. 2, steps 1, 2) and was presoaked (FIG. 2, step 3) prior to processing in a continuous thermomechanical/chemical countercurrent prehydrolysis reactor at 190° C. together with an aqueous solution of sodium hydroxide, at a concentration to achieve a pH of 11 which flows counter-current to biomass movement (FIG. 2, step 5). In this way a lignin-rich and/or hemicellulose-rich liquor is produced and separated from the cellulose-rich pulp by particle size exclusion and regional pressure variations. Optionally, a reactor such as described in U.S. Pat. No. 7,600,707 may be used.

The cellulose-rich pulp is directed to a saccharification step (FIG. 2, step 7) where enzymatic hydrolysis proceeds for 72 hours in the presence of cellulose-degrading and hemicellulose-degrading enzymes provided by Cellic CTec3 from Novozyme (Franklin, N.C., USA). Other cellulose and hemicellulose degrading enzymes may be used. For example food grade enzymes may be used. The cellulose-rich pulp contains lignin and hemicellulose, and some or portions of these may be removed, as desired. For example, it may be desirable to remove hemicellulose prior to an enzymatic hydrolysis.

The pulp solids are washed by the counter current functionality of the reactor simultaneously to mechanical defibration. Following saccharification, the remaining solid fraction is removed, and the carbohydrate fraction is mixed with malted and toasted hemp seeds and marijuana leaves and flowers to form a wort (FIG. 2, step 10).

After mashing and lautering at 65° C. for 60 minutes (FIG. 2, step 10), the seeds are separated (FIG. 2, step 11) and the extract is moved to the kettle where hops are optionally added and the liquid brought to a temperature of 90-100° C. for a period of 60 minutes (FIG. 2, step 12). The wort is cooled, trub solids separated out in steps 12 and 13 respectively and the wort is concentrated to obtain a fermentable carbohydrate concentration of 75 g/L glucose (FIG. 2 step 15). The wort is aerated and brewer's yeast with xylose metabolizing ethanogenic yeast are added and fermentation of the wort occurs over 7-21 days until an 5% alcohol content is achieved.

Phytocannabinoids such as THC and CBD are measured. Optionally if the concentration of THC is not as desired, a marijuana oil can be added. A natural emulsifier to ensure stability is added to the beverage to reach a target THC of 5 mg/L. The beverage is aged for 11 days, carbonated and bottled. This beverage contains both alcohol and appreciable amounts of psychoactive compounds from the Cannabis plant. NOTE: At the time of the writing of this patent, a product like this would no be legal for sale in most jurisdictions where Cannabis is legal for recreational or medical use.

### Example 8

Fermentable Extract and Fermented Beverage Prepared from Cannabis (Hemp), with Hydrothermal Prehydrolysis Step

In this example, a method is outlined for preparation of a beverage from Cannabis (hemp) plant components, using hydrothermal prehydrolysis (FIG. 2, step 4) followed by enzymatic saccharification (FIG. 2 step 8). The resulting extract was fermented with brewer's yeast, and a beverage of about 6% alcohol is prepared.

Plant Preparation and Milling

Cannabis (hemp) stalk and stem was milled to a particle size between 0.1 and 2″ and screened for dirt and contaminants (FIG. 2, step 1).

Pre-Soak Pre-Steam (FIG. 2, Step 3)

Cannabis (hemp) was pre-soaked at a temperature of 60° C. for a time period of 60 minutes with adjustment of the moisture content as appropriate.

Prehydrolysis 1—Hydrothermal (FIG. 2, Step 4)

Cannabis (hemp) plants were processed, in two batches of 25 kg Cannabis (hemp) each, in a horizontal digester using food grade caustic soda (NaOH). Batches were cooked using approximately 10% w/w consistency (ie—10% by weight of biomass to water).

InnoFibre Centre for Innovation of Cellulosic Products (Trois-Rivieres, Quebec, Canada) conducted analysis prior to prehydrolysis. Prehydrolysis conditions for Cannabis (hemp) Batches #1 and #2 were as follows. Type of Biomass: Cannabis (hemp); Total Biomass: 25 kg (#1), 20 kg (#2); NaOH: 5 g/100 g biomass (ie—NaOH at 1.25 kg); Hot water: 200 L; Heating time: from 62-150° C.): 74 min (#1), 72 min (#2); Pressure at holding temperature: 375 kilopascal gauge (kPag) (#1), 370 kPag (#2) (relative to atmospheric pressure); Depressurization time: 20 mins (#1), 27 mins (#2); Final volume (biomass+initial water+condensing water) 280 L; Final dry biomass after washing: 17 kg (#1), and 13 kg (#2) (on a dry basis).

In general, a first reactor may be used with food grade caustic (5% w/w biomass), 150° C.-240° C. for 2 hrs, at heat times from 30 mins to 4 hours, such as about 72-74 min, depressurize time can be from 10 to 60 mins, for example 20-27 min.

Centrifugation was used to remove a portion of hemicelluloses and lignin. The residual pulp was reduced in particle size to <2 mm prior to saccharification.

Hemicellulose and/or lignin was removed downstream of prehydrolysis by draining and washing under pressure with alkaline aqueous or aqueous/ethanol mixture at 30 to 60° C. A second stage washing was done with water. The biomass was squeezed to remove excess water.

Saccharification

Enzymatic hydrolysis was carried out using food grade cellulase and/or hemicellulase enzymes commercially available, In this case 7.5 L Celluclast and 7.5 L UltraFlow Max (Novozyme); and 3 L Optimash Barley (Genencor) was used under pH control with the addition of a base such as potassium hydroxide and an acid such as sulfuric acid to maintain pH of 4.5 to 6.5. The enzyme was added at a concentration of 2 to 10% w/w of the cellulose fraction in the Cannabis biomass. Enzymatic hydrolysis was conducted on Cannabis (hemp) feed at 15% consistency (15% biomass pulp to liquid) with food grade cellulase and hemicellulase, with a pH that is maintained between pH 4.5-6.0.

The enzymatic hydrolysis was conducted in a 500 L bioreactor filled with 30 kg of pretreated Cannabis (hemp) (dry basis) and 230 L. The reactor was sterilized at 121° C. for 30 mins. The reactor was then cooled to 55° C. before adding the enzymes as a cocktail which consisted of 7.5 L Celluclast (Novozyme), 7.5 L Ultraflow Max (Novozyme) and 3 L Optimash Barley (Genencor/DuPont). Hydrolysis was conducted for 4 days (96 hours). Harvesting was conducted. Parameters and results from enzymatic hydrolysis are provided below. Samples were taken every day, and variability assessed. The final sampling at 96 hours was done on 3 representative samples harvested separately.

Solid/Liquid Separation after Enzymatic Hydrolysis (FIG. 2, Step 9)

After enzymatic hydrolysis, screening was conducted, to remove large particles of residual woody matter. Further, centrifugation was used to separate carbohydrates (glucose and xylose mostly) from lignin and residual solids.

The residual Cannabis biomass solids were separated from the liquid dissolved carbohydrate stream (extract) in a first stage screening to remove larger particles and then a second stage using centrifugation technology such as a continuous decanter or continuous centrifuge.

Carbohydrate Concentration (FIG. 2, Step 14)

The carbohydrate-containing stream, or fermentable extract, formed in this way was predominantly a mixture of glucose, xylose, glucooligomers and xylooligomers. This stream was subsequently concentrated using reverse osmosis or vacuum evaporation to a concentration of 75-150 g/L glucose prior to fermentation. This step can be alternatively done upstream of fermentation at any point.

Further Use in Preparation of a Beverage.

The carbohydrate stream or fermentable extract so formed was ready for use in the fermentation process for preparation of a beverage, such as outlined herein.

The fermentable extract prepared in this way can go on to preparation of the fermented beverage, such as for brewing a beer. A number of options may be utilized in the brewing process, as described herein, and as known to brewers. For example, the extract can be mashed with roasted and/or malted hemp seeds (65° C.), within a kettle with hops, and boiled. Fermentation was carried out by a lager yeast, in this case a yeast strain from Weihenstephan in Germany was used (SafLager W-34/70), at 12-18° C., for 4 days.

Following carbonation, a beer product with about 6% alcohol by volume was formed.

### Example 9: Preparation of Fermentable Extract and Fermented Beverage Using Supercritical CO₂ with Sub-Critical or Near-Critical Water Prehydrolysis Process with Dilute Acid as Final Hydrolysis

The fermentable extract prepared according to this method involves preparation steps as outlined in Example 8, with the exception that the prehydrolysis step follows the procedure as outlined below involving super critical CO₂ and/or sub-critical or near-critical water prehydrolysis with subsequent dilute acid hydrolysis. Notably, enzymatic hydrolysis is not required, as dilute acid hydrolysis is used to degrade the plant polymers to carbohydrates and create the extract. Parameters not described below follow Example 8.

In this example, a method is outlined for supercritical water prehydrolysis process with dilute acid, as final hydrolysis of Cannabis plants or plant components.

Milling and Pre-Soak Pre-Steam Treatment (FIG. 2, Steps 2, 3)

Cannabis is milled to a particle size between 200 micron and 2″, for example at 500 micron. Particle size reduction can be achieved using a refiner or any appropriate means. A pre-soak pre-steam process may be used. For example, Cannabis may be pre-soaked or pre-steamed at a temperature of from 25 to 60° C. for a time period of 5 to 120 min and adjusting the moisture content as appropriate.

Prehydrolysis Reactor 1 (FIG. 2, Step 4):

First stage prehydrolysis is carried out by heating the biomass to a first stage temperature of 150° C. to 190° C. for a first stage time of 30 minutes to 3 hours at a first stage pressure of 105 to 150 psig. The reactor may be a Pandia type digester or other, horizontal or vertical, batch or continuous. A catalyst is not used and hemicellulose is preferentially separated.

Prehydrolysis Reactor 2 (FIG. 2, Step 7):

The contents of reactor 1 are fed into a second reactor for supercritical hydrolysis using CO₂ and/or sub-critical or near-critical water and heat only and obtaining the supercritical point of the mixture until the water behaves like a liquid and a gas solubilizing the cellulose (647.096 K, >22.064 MPa) (373.946° C. and 3200.11 psig). Further details of the procedures described in this example may be found in U.S. Pat. No. 8,546,560 to Renmatix, Inc. (Plantrose Process), and are only described briefly here. High temperature and high pressure conditions in the second reactor causes the feedstock cellulose to become solubilized. The reaction is subsequently quenched.

The biomass is processed in batch or continuous mode for a time of 1 sec to 10 sec residence time. The end product is a liquid with short chain polymeric carbohydrates and a solid phase that is lignin. Lignin is separated from the liquid polymeric carbohydrates.

The hemicellulose stream separated out may be added back to the mixture of cellulose polymeric carbohydrates.

Saccharification by Dilute Acid Hydrolysis (FIG. 2, Step 8)

Dilute acid hydrolysis is carried out using food grade sulfuric acid to produce monomeric carbohydrates.

The resulting carbohydrate stream so formed is ready for use in the fermentation process for preparation of a beverage, such as outlined in any one of the previous Examples, such as in Example 8.

### Example 10 Fermentable Extract and Fermented Beverage Prepared with Supercritical Water Prehydrolysis Process with Enzymes as Final Hydrolysis

In this example, a method parallel to that of Example 8 and/or 9 is provided. Supercritical CO₂/sub-critical or near-critical water prehydrolysis is used, followed by enzymes as a final hydrolysis of Cannabis plants or plant components. Parameters not described below follow Example 8 and/or Example 9.

Milling (FIG. 2, Step 2):

Cannabis is milled to a particle size between 0.1 and 2″.

Pre-Soak Pre-Steam (FIG. 2, Step 3):

Cannabis may be pre-soaked or pre-steamed at a temperature of 25 to 60° C. for a time of from 5 to 120 min and the moisture content is adjusted as needed.

Prehydrolysis Reactor 1 (FIG. 2, Step 4):

First stage prehydrolysis is carried out by heating the biomass to a first stage temperature of 150° C. to 190° C. for a first stage time of 30 minutes to 3 hours at a first stage pressure of 105 to 150 psig. The reactor may be a Pandia type digester or other, horizontal or vertical, batch or continuous. A catalyst is not used and hemicellulose is preferentially separated.

Prehydrolysis Reactor 2 (FIG. 2, Step 7):

The contents of reactor 1 are fed into a second reactor for supercritical hydrolysis using water and heat only and obtaining the supercritical point of the mixture until the water behaves like a liquid and a gas solubilizing the cellulose (647.096 K, >22.064 MPa) (373.946° C. and 3200.11 psig). Cellulose hydrolysis proceeds when cellulose comes into contact with a fluid mixture of supercritical CO₂ and sub- or near-critical water.

The biomass is processed in batch or continuous mode for 1 sec to 10 sec residence time. The end product is a liquid with short chain polymeric carbohydrates and a solid phase that is lignin. Lignin is separated from the liquid polymeric carbohydrates.

The hemicellulose stream that is separated out may be added back to the mixture of cellulose polymeric carbohydrates.

Saccharification by Enzymatic Hydrolysis (FIG. 2, Step 8)

Enzymatic hydrolysis is performed to produce monomeric carbohydrates. Enzymatic hydrolysis is carried out using food grade cellulase and/or hemicellulose enzymes commercially available under pH control with the addition of a base such as potassium hydroxide and an acid such as sulfuric acid to maintain pH of 4.5 to 6.5. The enzyme is added at a concentration of 2 to 10% w/w of the cellulose fraction in the Cannabis biomass.

The carbohydrate stream formed as a result of the hydrolysis may optionally be further purified and used in the fermentation process for preparation of a beverage, such as outlined in any one of the methods described in Examples 1 to 7.

### Example 11 Fermentable Extract and Fermented Beverages Produced with Prehydrolysis at Appropriate Pressures for Temperatures from 150° C. to 190° C.

In this example, an autohydrolysis prehydrolysis step was performed at elevated pressure followed by a thermomechanical prehydrolysis using a refiner. Other parameters not indicated here may follow the method described in previous examples.

Details of procedures noted herein may be found in U.S. Pat. No. 9,580,454 to FPInnovations. An overview of procedures are described briefly, as follows.

Milling (FIG. 2, Step 2)

Cannabis is milled to a particle size between 0.1 and 2″.

Pre-Soak and Washing of Biomass and Chemical Treatment (FIG. 2, Steps 4, 5)

Cannabis is pre-soaked at a temperature of 25 to 60° C. for a time period of 5 to 120 min and adjusting the moisture content and washed.

Prehydrolysis Reactor 1 (FIG. 2, Step 4):

First stage prehydrolysis is carried out by heating the biomass to a first stage temperature of 150° C. to 190° C. for a first stage time of 30 minutes to 3 hours at a first stage pressure of 105 to 150 psig. The reactor may be a Pandia type digester or other, horizontal or vertical, batch or continuous. A catalyst is not used and hemicellulose is preferentially separated

Extraction of Hemicelluloses in a Reactor

Hemicellulose can be extracted from the pretreated substrate by either a biological or chemical agent, and further processed to high value bioproducts (i.e. xylooligomers, flavonoids) to add back into the fermented beverage, such as a beer. Mild acids and alkali, enzymes, oxidants, and other chemicals may be used. Temperatures below 100° C. may be utilized. Acetic acid, dilute sulfuric acid, hydrochloric acid, sodium hydroxide, or hydrogen peroxide, may be used. Temperatures of 20° C. to 145° C. for 1 to 30 minutes may be used, allowing recovery of a hemicellulose fraction as a product.

Removing Hemicellulose by Use of a Centrifuge

A solid/liquid separation step is employed to drain off a hemicellulose-rich portion with fiber washing in a centrifuge

Mechanical Refining (FIG. 2, Step 6)

The biomass may be mechanically refined using a low-pressure refining method with minimum energy, to disintegrate the lignocellulosic feedstock and activate the separation of cellulose, lignin and hemicellulose in subsequent steps. The refining energy may suitably be from 700 to 4500 MJ/t, and refining pressure may be in the range of 100 to 600 kPa, more preferably 200 to 400 kPa. Chemicals or biochemicals such as enzymes or alkaline peroxide may be added before or during the process to help facilitate the subsequent steps.

Saccharification by Enzymatic Hydrolysis (FIG. 2, Step 8)

The hydrolysis may be conducted as described in previous Examples, such as for example, at 50° C., at pH 4.8, with cellulase and/or hemicellulase. Enzymatic hydrolysis is carried out using food grade cellulase and/or hemicellulase enzymes commercially available under pH control with the addition of a base such as potassium hydroxide and an acid such as sulfuric acid to maintain pH of 4.5 to 6.5. The enzyme is added at a concentration of 2 to 10% w/w of the cellulose fraction in the Cannabis biomass. The hydrolysis may suitably be carried out at a pH of from 3 to 9, at 10-80° C. for up to 144 hours. High-consistency (up to 30%) hydrolysis is preferred to increase the concentration of carbohydrates. Hydrolysis yield above 95% can be obtained.

Solid/Liquid Separation after Enzymatic Hydrolysis (FIG. 2, Step 9)

The lignin fraction can be separated from the carbohydrate fraction, so that the lignin fraction and carbohydrate fraction are recovered. The residual Cannabis biomass solids are separated from the liquid dissolved carbohydrate stream (extract) in a first stage screening to remove larger particles. Subsequently, a second stage separation is conducted using centrifugation technology, such as a continuous decanter or continuous centrifuge.

Carbohydrate Concentration (FIG. 2, Step 14)

The carbohydrate stream which is predominantly a mixture of glucose, xylose, glucooligomers and xylooligomers, is concentrated using reverse osmosis or vacuum evaporation so as to reach a concentration of from 75 to 150 g/L glucose, depending on the desired alcohol content of the fermented product.

Subsequent steps in the method can be carried out according to other examples, such as Example 8.

### Example 12 Beverage Evaluation of Consumers Acceptance Parameters

In this example, beverages brewed according to Example 8 were evaluated a variety of consumer acceptance parameters. Consumer acceptance is important in the preparation of fermented beverages.

FIG. 3 depicts the scorecard entitled “Beer Evaluation Sheet” obtained from the Beerology™ (Canada) used to evaluate multiple characteristics of the beverages in six categories: (1) Appearance: Color, Clarity, Head; (2) Aroma: Intensity Balance, Impression; (3) Flavour: Intensity, Balance, Impression; (4) Mouthfeel: body; carbonation; (5) Finish: length, intensity, balance; and (6) General Impression: craftsmanship; freshness, personal taste.

Four subjects were provided with a beer prepared and described above according to the process of Example 8, and were asked to evaluate the beer.

Table 6 provides beer evaluation scores for the properties outlined on the evaluation sheet of FIG. 3, normalized to a percentage scale by measuring the distance along a line as a percentage of the length of the line from the left-side.

TABLE 6
Summary of Consumer Evaluation Scores
for Properties of Lager Beer

| Property (spectrum end | Subject Number | | | | |
|---|---|---|---|---|---|
| points “0-100”) | 1 | 2 | 3 | 4 | Average |

Appearance

| | | | | | |
|---|---|---|---|---|---|
| Color (light-dark) | 28 | 42 | 40 | 30 | 35 |
| Clarity (brilliant-cloudy) | 15 | 15 | 31 | 6 | 17 |
| Head (poor-persistent) | 47 | 47 | 47 | 53 | 49 |

Aroma

| | | | | | |
|---|---|---|---|---|---|
| Intensity (faint-strong) | 59 | 53 | 60 | 58 | 58 |
| Balance (sweet-sharp) | 47 | 34 | 53 | 23 | 39 |
| Impression (off-nice) | 73 | 66 | 100 | 73 | 78 |

Flavour

| | | | | | |
|---|---|---|---|---|---|
| Intensity (faint-strong) | 44 | 47 | 34 | 44 | 42 |
| Balance (sweet-sharp) | 38 | 53 | 13 | 20 | 31 |
| Impression (off-nice) | 76 | 44 | 68 | 64 | 63 |

Mouthfeel

| | | | | | |
|---|---|---|---|---|---|
| Body (light-full) | 35 | 31 | 60 | — | 42 |
| Carbonation (faint-excessive) | 32 | 50 | 39 | 23 | 36 |

Finish

| | | | | | |
|---|---|---|---|---|---|
| Length (short - long) | 64 | 50 | 68 | 44 | 56 |
| Intensity (faint-strong) | 64 | 62 | 34 | 38 | 50 |
| Balance (sweet - bitter) | 50 | 53 | 47 | 59 | 52 |

General Impression

| | | | | | |
|---|---|---|---|---|---|
| Craftsmanship (boring-excellent) | 76 | 56 | 84 | 70 | 71 |
| Freshness (off-fresh) | 82 | 62 | 87 | 82 | 78 |
| Personal Taste (disliked-liked) | 82 | 62 | 81 | 59 | 71 |

These results indicate good overall acceptance of the beer prepared according to the method described in Example 8 herein. The appearance of the beer had a generally light color, good clarity, a good head integrity. Regarding aroma, the intensity was slightly strong, and the balance of aroma was middling between sweet and sharp. The impression of the aroma was generally good. Flavour parameters indicated the beer was leaning more toward mild than strong, a balance tipped toward sweet, and an overall nice flavor impression. Mouthfeel of the beer tended toward a light body, with faint carbonation. The finish of the beer was long-lasting, with a slightly strong intensity, but a good balance between sweet and bitter. The general impressions of the consumers was that the beer exhibited good craftsmanship, a good freshness score, and was overall well-liked.

These data affirm that the beer brewed as described herein by using Cannabis plants results in a likable product that consumers are, on balance, liable to find quite acceptable.

### Example 13: Data and Results from Example 8, Pilot Production of Hemp Beer

Analysis of carbohydrates, organic acids and alcohols was performed using an Agilent HiPlex-H column on an Agilent 1260 system, 0.6 ml/min, 65° C. Refractive Index Detector (55° C.), Loyalist College Belleville, ON. Standards were purchased and calibrations performed for maltotriose, cellobiose, glucose, xylose, galactose, mannose, arabinose, acetic acid, formic acid, lactic acid, levulinic acid, ferulic acid, p-coumaric acid, guaiacol, vanillic acid, cinnamic-trans acid, 5-hydroxymethylfurfural, furfural. The following analytical methods were used to characterize solids composition: NREL/TP-510-42621, revised March 2008, NREL/TP-510-42618, revised July 2011, NREL/TP-510-42622, revised January 2008. The following methods were used to characterize slurry compositions: NREL/TP-510-42623, revised January 2008. The following analytical method was used to characterize and total dissolved solids: NREL/TP-510-42618, revised July 2011).

The monosaccharides xylose, galactose and mannose could not be resolved from each other using this method and so was grouped together as xylose+mannose+galactose, (XGM). The composition of the feed hemp was measured to be, on a dry basis: lignin 23.40 g/L, glucan 37.63 g/L; XGM 4.83 g/L; arabinan 0.26 g/L; acetyl 4.90 g/L; ash 0.01 g/L.

Table 4 shows the composition of the hemp feed measured

TABLE 4

| Summary | % Lignin | % Glucan | % XGM | % Arabinan | % Acetic | % Ash | Totals |
|---|---|---|---|---|---|---|---|
| UPTH-Ch-B1-1a | 23.0642 | 36.8919 | 4.7356 | 0.2627 | 4.9825 | 0.0166 | 69.9535 |
| UPTH-Ch-B1-1b | 23.1632 | 36.7816 | 5.0544 | 0.2962 | 4.7703 | 0.0156 | 70.0813 |
| UPTH-Ch-B1-1c | 23.0499 | 38.5723 | 4.8102 | 0.2881 | 4.8089 | 0.0133 | 71.5428 |
| UPTH-Ch-B1-1d | 23.6687 | 35.2963 | 4.5448 | 0.2713 | 4.8157 | 0.0163 | 68.6130 |
| UPTH-Ch-B1-1e | 24.1756 | 38.3310 | 4.9153 | 0.1517 | 5.0597 | 0.0122 | 72.6454 |
| UPTH-Ch-B1-1f | 23.2810 | 39.8855 | 4.8915 | 0.3074 | 4.9493 | 0.0124 | 73.3271 |
| Averages | 23.4005 | 37.6264 | 4.8253 | 0.2629 | 4.8977 | 0.0144 | 71.0272 |

Hemp Extract Analysis after Enzymatic Hydrolysis in Process Stream from Example 8:

After enzymatic hydrolysis, values were obtained as follows, DP3—1.14 g/L; Cellobiose—1.06 g/L; Glucose—40.27 g/L; XGM—9.83 g/L (An Agilent HPLC and an Agilent HiPlex-H column was used. Ion chromatography was conducted at Loyalist College, Belleville, ON).

Hemp Extract Analysis after Solids and Lignin were Removed by Centrifugation in Process Stream in Example 8:

After centrifuging the hemp extract to remove lignin and solids, values were obtained as follows, DP3—1.14 g/L; Cellobiose—0.94 g/L; Glucose—39.81 g/L; XGM—9.81 g/L (An Agilent HPLC and an Agilent HiPlex-H column was used. Ion chromatography was conducted at Loyalist College, Belleville, ON.)

Hemp Extract Analysis after Concentration by RO in Process Stream from Example 8:

After concentrating the hemp extract using reverse osmosis, values were obtained as follows, before brewing: DP3—3.98 g/L; Cellobiose—4.23 g/L; Glucose 85.10 g/L; Xylose 12.34 g/L. (An Agilent HPLC and an Agilent HiPlex-H column was used. Ion chromatography was conducted at Loyalist College, Belleville, ON.)

Hemp Wort Analysis Before Brewing in Process Stream in Example 8

DP3—4.66 g/L; Cellobiose—3.73 g/L; Glucose 87.18 g/L; Xylose 14.52 g/L. (An Agilent HPLC and an Agilent HiPlex-H column was used. Ion chromatography was conducted at Loyalist College, Belleville, ON.)

Analysis of Beer at 72 Hours of Fermentation in Process Stream in Example 8

DP3—4.79 g/L; Cellobiose—4.28 g/L; Glucose 11.33 g/L; Xylose 13.78 g/L; Ethanol—38.50 g/L. (An Agilent HPLC and an Agilent HiPlex-H column was used. Ion chromatography was conducted at Loyalist College, Belleville, ON.)

Analysis of Beer at 89 Hours of Fermentation in Process Stream in Example 8

DP3—4.40 g/L; Cellobiose—4.15 g/L; Glucose 1.92 g/L; Xylose 11.99 g/L; Ethanol—41.40 g/L. (An Agilent HPLC and an Agilent HiPlex-H column was used. Ion chromatography was conducted at Loyalist College, Belleville, ON.)

Analysis of Beer at 96 Hours of Fermentation in Process Stream in Example 8

DP3—5.34 g/L; Cellobiose—4.83 g/L; Glucose 2.27 g/L; Xylose 14.10 g/L; Ethanol—46.39 g/L. (An Agilent HPLC and an Agilent HiPlex-H column was used. Ion chromatography was conducted at Loyalist College, Belleville, ON.)

### Example 14: Data and Results for Xylooligosacharide Analysis in Beer and Extracts in Process Stream from Example 8

The total gluco- and xylo-oligomers were measured in the beer produced using example 8. The method details can be found in NREL/TP-510-42623, revised January 2008. In summary, this method adds H₂SO₄ until the concentration of the sample is 4%, followed by heating to 121° C. for one hour to hydrolyze all gluco- and xylo-oligomers. The concentration of glucose and xylose liberated in this procedure will be used to calculate the total of each of gluco- and xylo-oligomers that existed in the beer prior to acid hydrolysis. The acid hydrolysis of the beer sample was performed in triplicate.

Table 8 shows the total gluco- and xylo-oligomers measured in lager beer produced using the process in example 8.

Unknown peaks (listed by retention times only (RT) were quantified using the component calibration curve of maltotriose (DP3). On this basis, upon acid hydrolysis, there was a loss of polysaccharides of 17.16 g/L (with RT<11.4, glucose), a gain of glucose liberated of 13.54 g/L a gain of XGM liberated of 4.49 g/L XGM and arabinose of 1.9 g/L. This indicates that there were approximately 4.49 g/L xylo-oligomers and 13.54 g/L gluco-oligomers.

TABLE 8
Acid hydrolysis of gluco- and xylo-oligomers in hemp beer (sample
PB-HLager-InnPT-06-06-2018) for quantification.

| [symbol] | | | | | | | | | |
|---|---|---|---|---|---|---|---|---|---|
| | | [symbol] After acid | [symbol] After acid | [symbol] After acid | Average after | | | | |
| [symbol] | | hydrolysis | hydrolysis | hydrolysis | acid hydrolysis | [symbol] | [symbol] | [symbol] | Average |
| | Before Acid | [symbol] 1 hr | [symbol] 1 hr | [symbol] 1 hr | [symbol] 1 hr | Difference | Difference | Difference | Difference |
| compound | Hydrolysis | [symbol] % H2SO4 | [symbol] % H2SO4 | [symbol] % H2SO4 | [symbol] % H2SO4 | Gain [symbol] g/L | Gain [symbol] g/L | Gain [symbol] g/L | Gain [symbol] |
| | g/L | g/L | g/L | g/L | | g/L | g/L | g/L | |
| [symbol] | 0.00 | 0.00 | 0.00 | 0.00 | 0.00 | 0.00 | 0.00 | 0.00 | 0.00 |
| [symbol] | 0.00 | 0.71 | 0.00 | 0.73 | 0.45 | 0.71 | 0.00 | 0.73 | 0.45 |
| [symbol] | 5.14 | 0.00 | 0.00 | 0.00 | 0.00 | −5.14 | −5.14 | −5.14 | −5.14 |
| [symbol] | 0.00 | 0.49 | 1.42 | 0.59 | 0.55 | 0.49 | 1.42 | 0.59 | 0.55 |
| [symbol] | 5.10 | 1.55 | 1.53 | 1.43 | 1.54 | −3.43 | −3.27 | −3.57 | −3.45 |
| [symbol] | 20.00 | 2.89 | [symbol] | 2.66 | [symbol] | −17.51 | −17.45 | −15.04 | −17.77 |
| [symbol] | 0.00 | [symbol] | 10.22 | [symbol] | [symbol] | [symbol] | 10.22 | [symbol] | [symbol] |
| [symbol] | 2.01 | 0.00 | 1.59 | 1.45 | 1.06 | −2.01 | −0.32 | −0.55 | −0.97 |
| [symbol] | 4.05 | 17.10 | 15.24 | 17.45 | 17.50 | 13.03 | 14.15 | 13.41 | 13.54 |
| [symbol] | 14.47 | 15.41 | [symbol] | 15.54 | 15.95 | 3.94 | [symbol] | 4.37 | 4.49 |
| [symbol] | 0.00 | 1.71 | [symbol] | 2.00 | 1.90 | 1.71 | 1.93 | 2.00 | 1.90 |
| [symbol] | | | | | | | | | |

[symbol]

indicates data missing or illegible when filed

### Example 15: Data and Results of Analysis of Cannabinoid Profile and Potency in Beer from Example 8

There were no phytocannabinoids detected in the hemp beer produced in example 8 (PB-HLager-InnPT-06-06-2018) from the list: THC (D9 and D8), THCA, CBD, CBDA, CBG, CBGA, CBC, CBN, THCV and CBDV (30 ppm sensitivity) using convergence chromatography. Market beers were also tested and did not detect any phytocannabinoids were: Buzz Beer (Cool Beer Brewing Co., Toronto ON., Canada) and The Hemperor (New Belgium Brewing Co., Asheville, N.C., USA). This analysis was performed by ProVerde Labs 420 Fortune Blvd., Millford Mass., USA.

### Example 16: Data and Results of Terpene Analysis of Beer from Example 8

Terpene analysis was performed on the hemp beer produced in example 8 (PB-HLager-InnPT-06-06-2018) using head-space gas chromatography for the standard profile list of 35 terpenes as follows: myrcene, Pulegone, isopulegol, borneol, menthol, nerolidol-cis, G-terpenine, nerolidol-trans, A-bisabolol, linalool, linalyl acetate, B-caryophyllene, caryophyllene oxide, eugenol, guaiol, sabinene, humulene, P-cymen, terpineol, camphene, fenchone, B-pinene, eucalyptol, A-terpenine, 3-carene, A-pinene, citral-1, citral-2, limonene, citronellol, geraniol, ocimene-2, ocimene-1, A-phellandrene, terpinolene. Market beers were also tested as follows: Buzz beer (Toronto Brewing Co.) and Hemperor (New Belgium). This analysis was performed (Table 9) by ProVerde Labs 420 Fortune Blvd., Millford Mass., USA.

TABLE 9
Terpene analysis in the beer produced in example 8

| Terpene Analysis | | | | | | | | |
|---|---|---|---|---|---|---|---|---|
| Summary | Mercene | Nerolidol-trans | A-Bisabolol | B-Caryophyllene | Caryophyllene-oxide | Guaiol | Humulene | Terpinolene |
| Buzz Beer, Toronto | 1 | 4 | 24 | 7 | 3 | 3 | 6 | 2 |
| Brewing | | | | | | | | |
| PB-Hlager-InnPT- | 0 | 2 | 9 | 4 | 1 | 1 | 2 | 5 |
| 06-06-2018 | | | | | | | | |
| The Hemperor, HPA, | 0 | 1 | 2 | 2 | 0 | 0 | 1 | 5 |
| New Belgium | | | | | | | | |

### Example 17: Data and Results for More Flavonoid Analysis on Market Beers and Beer Produced in Example 8

Methodology: Samples were run in triplicate through LCMS and GCMS analysis. Three of these samples were store bought beers: Heineken Lager, Humboldt Hemp Seed Ale, and Lagunitas IPA. The other samples were supplied by the inventors and were labeled PBHAIe 5-18 (extract produced in example 8 fermented with ale yeast), PBHAIe 5-14 (extract produced in example 8 fermented with ale yeast), PBHExt Before RO, PBHExt After RO, 31807 (PBHExt After centrifuge), 31808 (Buzz Beer, Toronto Brewing), 31809 (PB-HLager-InnPT-06-06-2018).

The preparation was run in a “neat” fashion. This means that the samples were transferred directly into HPLC vials (amber for GC and clear for LC) and run on the machine with no dilution.

GC-MS traces show many distinct features in the beers brewed from Cannabis using the method herein as compared to other hemp and hop beers tested. None of those differences were due to flavonoids or terpenoids or cannabinoids, to the best of our ability to identify peaks using the NIST library search for background-subtracted quadrupole mass spectra. The differences were tentatively identified as (from early elution to late): small organic acids, small linear, then cyclic poly-alcohols (di-, tri-), then polycyclic poly-alcohols and mono-saccharides and medium chain fatty acids (the latter two constituting the two large broad bands around 20 and 23 minutes).

More specifically, the method used for GC-MS analysis was as follows: samples of the beers were filtered to 0.22 um and 1 uL was injected using an autosampler into a Shimadzu QP2010-Series gas chromatograph with a TQ8040 mass spectrometer. The injector temperature was 280 C with a 1:10 split. The column was a Restek Rtx-5MS, 30 m×0.25 mm, 0.25 um df. The flow control was constant velocity at 36.3 cm/s (approximate flow rate of 1 mL/min). The oven temperature started at 50 C with a 1 minute hold, ramped to 100 C at 5 C/s, to 200 C at 10 C/s, and to 300 C at 20 C/s with a 4 minute hold at 300 C. The mass spectrometer was operated in Q3Scan mode from 42-600 Daltons at 10000 D/s and data acquisition rate of 5 spectra/s, >10 points across even 3 second peaks. Compounds were identified using background subtracted mass spectra forward searched into NIST08.LIB or NIST08s.LIB.

Several compounds were identified in beers brewed from Cannabis using the method described herein PB-HLager-InnPT-06-06-2018) that were not present or not as prevalent by ratio, in other hemp beers. Identical tests were performed on the following hemp beers: Buzz Beer, Cool Beer, Toronto, Canada and “Hum HEMP ALE” (Humboldt beer hemp ale, Humboldt, Calif.).

One well-identified compound was present in the beer brewed from Cannabis using the method described herein that was in neither of the other two hemp beers examined: At 14.82 minutes, retention time, a methyl-benzenediol was observed, probably 3-methyl-1,2-benzenediol, but 4-methyl-1,2-benzenediol is also a possibility, though it scored lower on two library entries.

Several well-identified compounds were significantly more abundant in the beer brewed from Cannabis using the method described herein vs one or more of the other commercial hemp beers tested:

At 4.10 and 4.22 minutes retention time, multiple isomers of 2,3-butandediol were observed in the beer brewed from Cannabis using the method described herein in greater abundance that any of the other two hemp beers.

At 13.64 minutes retention time, a significant amount of 1,2-benzenediol was observed in the beer brewed from Cannabis using the method described herein, but only insignificant amounts were present in either of the other two commercial hemp beers studied.

At 13.86 minutes retention time, 1,4:3,6-dianhydro-alpha-d-glucopyranose was more abundant by a factor of 4 in the beer brewed from Cannabis using the method described herein compared with either of the other two commercial hemp beers (which were similar to each other).

At 15.45 and 16.40 minutes retention time, Isorbide peaks were stronger by a factor of 6-8 in the beer brewed from Cannabis using the method described herein when compared with the Buzz beer, which was itself significantly stronger than the humboldt (factor of >2).

Two peaks (8.84 and 15.84 minutes) appeared to be present only in the beer brewed from Cannabis using the method described herein, but are not adequately identified, though the experts performing the analysis determined they were likely fermentation products (carbohydrates).

One peak (8.35 minutes) is present in higher abundance in the beer brewed from Cannabis using the method described herein than in the Buzz beer and did not appear in the Humboldt beer, but is inadequately identified, though the experts performing the analysis determined it was likely fermentation products (carbohydrates).

### Example 18: Data and Results from Dynalene on Esters and Alcohols

The beer sample from example 8 (PB-HLager-InnPT-06-06-2018) was analyzed by GC-MS using a method heating the sample to 70° C. for 30 min. The beer sample was compared to Heineken Pilsner (Heineken International) and Warsteiner Pilsner, (Germany) and Buzz Beer (Cool Beer Brewing Co., Toronto ON., Canada.) A library search was performed to identify the spectra of each peak. Hexanoic acid ethyl ester was a unique compound found in the beer produced in the example 8. Hexanoic acid ethyl ester is the ester resulting from the condensation of hexanoic acid and ethanol. It has a pleasant pineapple smell. Ethyl hexanoate is a volatile ethyl ester found in alcoholic beverages and produced during fermentation by yeast. Ethyl esters are formed by the reaction of ethanol with a fatty acid. Ethyl hexanoate is responsible for flowery/fruity aromas, e.g. pineapple, blackberry, apple-peel and strawberry aromas.

### Example 19 Free Amino Nitrogen Analysis

The ninhydrin method estimates amino acids, ammonia, and the terminal nitrogen groups of peptides and proteins and is listed by the European Brewery Convention (EBC), MEBAK, and American Society of Brewing Chemists (ASBC) as the method of choice for FAN measurement.

Using the Eppendorf ninhydrin-based FAN method (Short Protocol No. 09, June 2015) the beer produced in example 8 (PB-Hlager-InnPT-06-06-2018) was analyzed for FAN levels. After performing analysis in triplicate, the results were: 141.012 mg/L, 141.982 mg/L, and 139.901. The average was calculated to be 140.97 mg/L. The average FAN for a market IPA beer ranges from 133 mg/L-175 mg/L, placing the 6% ABV trial beer produced in Example 8 in a comparable range. The analysis of the hemp extract that was concentrated after reverse osmosis, but prior to mashing (produced in example 8), was found to have a FAN of 98.030 mg/L. This would suggest that the wort has low FAN without malted hemp seed mashing steeping in the mashing process and with steeping of the malted Cannabis seeds the FAN levels are in line with optimal brewing practices.

Previous research has indicated that for brewing, there is a requirement of 3.33 mg of FAN for every gram of fermentable sugars, which converts to 273.06 mg/L required to ferment our sugars (example 8 and based on 82 g/L glucose).

### Example 2120: A 2.5% ABV Beer Produced Using a Thermomechanical/Chemical Extruder Reactor for Prehydrolysis

This example was conducted at PureHemp Technologies, Colorado, USA. Hemp stalk and stem was milled using a knife mill with a ½ inch screen. The milled hemp was fed into a prehydrolysis process consisting of a single reactor. The reactor was a continuous counter-current extruder, where the solution moving counter current to the hemp biomass was caustic soda. Washing stages were employed after the reaction zones in the length of the extruder. The reactor operated with a water to hemp ratio of 5:1 (20% consistency) and a hemp flow rate of 121.3 g/min. The reactor was operated at 207.9° C., under appropriate pressure to achieve this temperature. Caustic soda (NaOH) was used to solubilize lignin and hemicellulose and was mixed with the liquid at a concentration to achieve a loading of 14.7% w/w of NaOH to the hemp feedstock, on a dry weight basis. The reactor was under pressure and uses this pressure in a way to drain the liquid content, to remove a considerable amount of the liquid over the length of the reactor, removing with it a portion of the lignin and hemicellulose. Thereafter, a washing liquid was added, flowing counter-currently and further draining. This was to separate a cellulose-rich portion from a lignin-rich and/or hemicellulose-rich portion.

Hemp feedstock was also analyzed at the PureHemp Technologies, CO, USA. The feedstock analysis, on a % w/w dry basis is: Extractives—7.42%; lignin 13.45%; ash 3.21%; glucan 47.27%; mannan 3.19% and xylan 12.55%. NREL protocols were used.

The analysis of the pulp after prehydrolysis, on a % w/w dry basis was: lignin 4.44%; ash 4.37%; glucan 85.47%; mannan 1.04% and xylan 3.3%. This shows considerable lignin and hemicellulose removal.

Saccharification was performed using cellulose-degrading and hemicellulose-degrading enzymes (Novozyme's Cellic CTec3). Saccharification was run for 72 hours at 50° C., and a controlled pH of 5.4. The saccharification took place in a 10 L reactor operating at 200 rpm. The enzyme was added at 10% w/w of dry cellulose. A total of 1 kg of cellulose (1.2 kg pulp, dry basis) was treated in the bench top fermenter. A fed batch regime was undertaken, such that the biomass and enzymes were added twice. Batch 1 was 1514 g hemp pulp (wet) in 6900 g water operating at 50° C., 200 rpm. Enzyme (30 g) was added, a loading of 10% enzyme of total dry cellulose. Thus 600 g dry wt. cellulose was added to batch 1. At 6 hrs, batch 2 was started and a second 1514.1 g hemp pulp was added to the reactor along with 30.5 g enzyme. The saccharification proceeded at 50° C., maintaining a pH of 5.4, using ammonium hydroxide addition.

The result was an extract with a concentration of glucose of 44.65 g/L at 112 hr. A total of 8651 g extract, with a density of 1.017 g/ml (8.5 L) was produced with glucose concentration of 44.65 g/L.

The extract was heated to 65° C., and 48.2 g toasted and cracked hemp seeds were steeped for 20 minutes. The hemp seeds were removed. The extract was brought to a boil and hops were added along with yeast nutrients. The wort was boiled for 60 minutes, adding hops at various times. The wort was cooled to 21° C. and transferred to a fermenter, where San Diego super yeast (White Labs WLP #090) was added and fermented for 7 days. The temperature was lowered to 1.7° C., and aged 7 days, followed by carbonation and bottling. The beer had 2.5% ABV.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

### REFERENCES

The following references are herein incorporated by reference.
U.S. Pat. No. 6,620,292
U.S. Pat. No. 6,419,788
U.S. Pat. No. 7,600,707
U.S. Pat. No. 8,147,884
U.S. Pat. No. 8,546,560
U.S. Pat. No. 9,095,554
U.S. Pat. No. 9,567,558
U.S. Pat. No. 9,580,454
U.S. Pat. No. 9,642,882
U.S. Pat. No. 9,914,948
U.S. Patent Publication No. US2009/0285965 A1
U.S. Patent Publication No. US2015/0182455 A1
U.S. Patent Publication No. US2016/0010126 A1
Appendino, G., G. Chianese, O. Taglialatela-Scafati, Cannabinoids: occurrence and medicinal chemistry, Curr. Med. Chem. 18 (2011) 1085-1099.
Courtin, C. M., W. F. Broekaert, K. Swennen, G. Aerts, V. Van Craeyveld and J. A. Delcour. 2009. Occurrence of arabinoxylo-oligosaccharides and arabinogalactan peptides in beer. J. Am. Soc. Brew. Chem. 67(2):112-117.
De Backer, B., B. Debrus, P. Lebrun, L. Theunis, N. Dubois, L. Decock, A. Verstraete, P. Hubert, C. Charlier, Innovative development and validation of an HPLC/DAD method for the qualitative and quantitative determination of major cannabinoids in Cannabis plant material, J. Chromatogr. B 877 (2009) 4115-4124.
ElSohly, M. A., D. Slade, Chemical constituents of marijuana: the complex mixture of natural cannabinoids, Life Sci. 78 (2005) 539-548.
Piazzon, A, M. Forte and M. Nardini. 2010. Characterization of Phenolics Content and Antioxidant Activity of Different Beer Types J. Agric. Food Chem. 58, 10677-10683.
Shallom, D. and Shoham, Y. (2003) Microbial hemicellulases. Current Opinion in Microbiology, 6 (3), 219-228.

1. A fermented beverage comprising one or more carbohydrate derived from hydrolysis of cellulose, hemicellulose, and/or lignocellulose from one or more component of a Cannabis plant.

2. The fermented beverage of claim 1, wherein a portion of the one or more carbohydrate derived from the hydrolysis is fermented to alcohol.

3. (canceled)

4. (canceled)

5. (canceled)

6. (canceled)

7. The fermented beverage of claim 1, wherein said beverage comprises less than about 0.5 grams per liter of furfural and 5-hydrolxymethyfurfural (5-HMF); less than about 0.1 grams per of liter formic acid; and less than about 0.2 grams per liter of levulinic acid, ferulic acid, p-coumaric acid, guaiacol, trans-cinnamic acid, and vanillic acid.

8. (canceled)

9. (canceled)

10. The fermented beverage of claim 1, comprising:
3-methyl-1,2-benzenediol and/or or 4-methyl-1,2-benzenediol;
xylooligosaccharides;
phenolics derived from said one or more component of a Cannabis plant;
2,3-butandediol or isomers thereof;
1,2-benzenediol; 1,4:3,6-dianhydro-alpha-d-glucopyranose;
isorbide;
a flavonoid selected from the group consisting of Orientin, Isoorientin, Vitexin, Isovitexin, Isoquercitrin, Naringin, Myrcetin, Luteolin, or Quercetin;
natural flavoring from malted and/or toasted hemp seeds or both; and/or
hops.

11. (canceled)

12. (canceled)

13. (canceled)

14. (canceled)

15. The fermented beverage of claim 1, wherein the one or more carbohydrate comprises:
glucose—0.5 to 5.0 g/L,
xylose—0.5 to 15 g/L, and/or
cellobiose—0.5 to 5.0 g/L.

16. The fermented beverage of claim 1, from which at least a portion of alcohol has been removed, or from which all of the alcohol has been removed.

17. (canceled)

18. (canceled)

19. (canceled)

20. (canceled)

21. (canceled)

22. (canceled)

23. (canceled)

24. (canceled)

25. The fermented beverage of claim 1, comprising:
from about 0.1 to about 57 mg/L THC;
total phytocannabinoid level in the beverage from 0.15 mg/L to 71.4 mg/L;
from 0.5 to 10 ppm Orientin;
from 0.1 to 5 ppm Isoorientin;
from 5.0 to 50 ppm Vitexin;
from 0.1 to 5.0 ppm Isovitexin;
from 0.5 to 10.0 ppm Naringin;
from 0.1 to 5.0 ppm Myrcetin;
from 0.1 to 5.0 ppm Luteolin; and/or
from 0.1 to 5.0 ppm Quercetin.

26. (canceled)

27. (canceled)

28. (canceled)

29. (canceled)

30. (canceled)

31. (canceled)

32. The fermented beverage of claim 1, consisting of water, a carbohydrate derived from the hydrolysis of cellulose, hemicellulose and/or lignocellulose from one or more component of Cannabis plants, hops, phytocannabinoids from the Cannabis plant, and alcohol at a level of up to about 15% v/v.

33. A fermentable extract for use in preparation of a fermented beverage, said extract comprising one or more carbohydrate derived from hydrolysis of cellulose, hemicellulose, and/or lignocellulose from one or more component of a Cannabis plant.

34. The fermentable extract of claim 33, wherein the one or more carbohydrate comprises one or more of arabinose, galactose, glucose, mannose, xylose and cellobiose.

35. (canceled)

36. (canceled)

37. (canceled)

38. (canceled)

39. The fermentable extract of claim 33, comprising on a weight basis:
glucose at 6.5 to 15.0%, or at about 7.7%;
xylose at 1.0 to 2.5%, or at about 2.0%;
galactose at 0.01 to 0.2%, or at about 0.02%;
arabinose at 0.001 to 0.2%, or at about 0.005%;
mannose at 0.01 to 0.3%, or at about 0.05%; and/or
cellobiose at 0.05 to 0.3%, or at about 0.15%.

40. (canceled)

41. The fermentable extract of claim 33, wherein the ratio on a weight basis of glucose to the total of xylose, galactose, and mannose (XGM) combined is from 2.5:1 to 15:1, or is from 4:1 to 8:1.

42. (canceled)

43. (canceled)

44. A method for producing a fermented beverage from one or more component of a Cannabis plant, comprising the steps of:
(a) obtaining a cellulose-rich pulp from the one or more components of the Cannabis plant, which has been treated to release lignin and/or hemicellulose;
(b) degrading the cellulose-rich pulp into carbohydrates with enzymatic hydrolysis by one or more cellulose-degrading and/or hemicellulose-degrading enzymes, and/or with acid hydrolysis, to form carbohydrates;
(c) preparing a wort from the carbohydrates with or without sufficient yeast nutritional requirements and flavoring from portions of the Cannabis plant; and
(d) fermenting the wort to form the fermented beverage;
(e) optionally performing one or more finishing steps to finish the beverage, selected from the group consisting of: aging, alcohol removal, formulation, flavoring, addition of phytocannabinoids, addition of terpenes, addition of xylooligomers, addition of Cannabis extracts, addition of Cannabis oils, addition of accelerants to accelerate the onset of a bioactive effect, and addition of decelerants to shorten the duration of the bioactive effect.

45. The method of claim 44, wherein the step of (a) obtaining the pulp comprises:
releasing lignin by reducing the one or more component of the Cannabis plant, to form a lignin-rich liquor and a cellulose-rich pulp, which cellulose-rich pulp may also contain an appreciable amount of hemicellulose; and/or
releasing hemicellulose by reducing the one or more component of the Cannabis plant, to form a hemicellulose-rich liquor and a cellulose-rich pulp.

46. (canceled)

47. (canceled)

48. The method claim 44, wherein step (a) additionally comprises:
hydrothermal prehydrolysis of the pulp;
thermal-mechanical prehydrolysis of the pulp;
supercritical CO₂ prehydrolysis of the pulp;
sub-critical or near-critical water prehydrolysis of the pulp;
prehydrolysis of the pulp as performed by a counter-current reactor designed for continuous processing of lignocellulosic materials; and/or
prehydrolysis of the pulp as performed by a counter-current reactor designed for or capable of continuous processing of lignocellulosic materials.

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. The method of claim 44, wherein:
step (a) comprises heating to a temperature of from 150 to 240° C.; and/or
in step (a) the lignin and/or hemicellulose is released by milling the one or more component of the Cannabis plant with an aqueous solution of pH 8 to 13, and optionally the one or more component of the Cannabis plant is processed in a reactor, and the aqueous solution washes the component during processing through the reactor.

64. (canceled)

65. (canceled)

66. (canceled)

67. (canceled)

68. The method of claim 44, wherein in step (b) the pulp is degraded using acid hydrolysis or supercritical CO₂ and/or by one or more cellulose-degrading or hemicellulose-degrading enzymes, optionally from Aspergillus niger, Trichoderma reesei or both.

69. (canceled)

70. (canceled)

71. (canceled)

72. (canceled)

73. The method of claim 44, wherein in step (b) the pulp is degraded by Attenuzyme Pro, Amylase AG 300 L, Cellucast 1.5 L, Ultraflo Max, Viscozyme L (Novozyme); Cellulase 2000 L, Optimash Barley, Viscamyl Flow (Genencor/DuPont) Rohalase Barley L, Rohament CEP, Rohalase SEP (ABEnzymes), a blend of enzymes of food grade quality, drisealases, laminarinases, endo-glucanases, cellobiohydrolases, beta-glucosidases, xylanases, ligninases, lyticases, cellulases from Aspergillus niger, cellulases from Aspergillus sp., cellulases from Trichoderma reesei, cellulases from Trichoderma sp., cellobiohydrolase I and from Hypocrea jecorina, or mixtures thereof.

74. The method of claim 44, wherein:
the wort prepared in step (c) comprises free amino nitrogen in an amount of from 100 to 1000 mg/g in the wort; and/or
100% v/v of the carbohydrate in the wort is derived from Cannabis plant.

75. (canceled)

76. (canceled)

77. (canceled)

78. (canceled)

79. (canceled)

80. The method of claim 44, wherein the carbohydrates in the wort comprise:
glucose at 6.5 to 15.0%, or at about 7.7%;
xylose at 1.0 to 2.5%, or at about 2.0%;
galactose at 0.01 to 0.2%, or at about 0.02%;
arabinose at 0.001 to 0.2%, or at about 0.005%;
mannose at 0.01 to 0.3%, or at about 0.05%; and
cellobiose at 0.05 to 0.3%, or at about 0.15%,
and/or wherein:
the wort comprises toasted and/or malted Cannabis seeds, Cannabis flowers, leaves, hops, or a combination thereof.

81. (canceled)

82. (canceled)

83. (canceled)

84. (canceled)

85. The method of claim 44, wherein:
phytocannabinoids are added to the wort;
terpenes are added to the wort;
flavinoids are added to the wort; and/or
xylooligomers derived from the Cannabis plant are added to the wort.

86. (canceled)

87. (canceled)

88. (canceled)

89. The method of claim 44, further comprising the step of removing alcohol from the beverage to a level less than 5% alcohol by volume in the beverage, to a level less than 0.5% alcohol by volume in the beverage, or to a level of 0% alcohol by volume in the beverage.

90. (canceled)

91. (canceled)

92. The method of claim 89, wherein:
phytocannabinoids are added to the beverage;
the THC level in the beverage is from about 0.1 to about 57 mg/L; and/or
the total phytocannabinoid level in the beverage is from 0.15 mg/L to 71.4 mg/L.

93. (canceled)

94. (canceled)

95. The fermented beverage produced according to the method of claim 44.
